(19) United States
(12) Patent Application Publication
(10) Pub. No.: US 2014/0165119 A1
(43) Pub. Date: Jun. 12, 2014

(54) OFFLINE DOWNLOAD METHOD, MULTIMEDIA FILE DOWNLOAD METHOD AND SYSTEM THEREOF

(71) Applicant: Tencent Technology (Shenzhen) Company Limited, Shenzhen (Guangdong) (CN)

(72) Inventors: Gang Liu, Shenzhen (Guangdong) (CN); Chen Liang, Shenzhen (Guangdong) (CN)

(21) Appl. No.: 14/236,068

(22) PCT Filed: Apr. 24, 2013
(86) PCT No.: PCT/CN2013/074647

§ 371 Date: Jan. 29, 2014

(30) Foreign Application Priority Data
Apr. 24, 2012 (CN) 201210122178.4

(51) Int. Cl. H04N 21/232; H04N 21/2343; H04N 19/40

(52) U.S. Cl. CPC H04N 21/232; H04N 7/26941; H04N 21/234309
USPC 725/92

(57) ABSTRACT

An offline download method and a system thereof, and a multimedia file download method and a system thereof. The offline download system includes: at least two download servers, each of which is configured to feed back load information to a distribution server according to its own load and obtain data information from the Internet according to an offline task; the distribution server, configured to receive the load information, generate a scheduling rule, and distribute the offline task to the download servers according to the scheduling rule; and a storage server, communicatively connected with the download server cluster and configured to store the data information obtained by the download server cluster, and make the data information available for downloading. The offline download solution can schedule offline tasks according to the load of the download servers to improve utilization of the download servers.

### CROSS REFERENCE TO RELATED APPLICATIONS

This application is a national phase application of PCT Application No. PCT/CN2013/074647, filed Apr. 24, 2013, which claims priority to Chinese Application No. 201210122178.4, filed on Apr. 24, 2012, and entitled “A Video on Demand Method and System Thereof” The content of the above identified applications are incorporated herein by reference in their entirety.

### FIELD OF THE TECHNOLOGY

The present disclosure relates to network data download technology, and in particular, to an offline download method, a multimedia file download method, and systems thereof.

### BACKGROUND

With development of computer technologies and user requirements on high-definition screens, the storage space occupied by multimedia video files is increasingly larger. A multimedia video file tends to occupy 4 GB or 5 GB of storage. On the other hand, with the boom and development of multi-function integrated smart mobile devices, playing multimedia on a mobile device has become a trend, but the mobile device is currently capable of storing and processing only a multimedia file of a relatively small size. Therefore, a multimedia file that occupies a large space on a computer needs to be transcoded into a multimedia file that occupies a small space, which makes the file suitable for playing on a mobile device.

Typically, a file is transcoded by a local transcoder on user equipment such as a computer or a mobile device. The transcoding takes a period of time, which depends on CPU (Central Processing Unit) and GPU (Graphic Processing Unit) performance of the local computer and is usually several hours. The transcoding occupies the CPU drastically, and the local computer is hardly capable of processing other tasks during the transcoding, such that transcoding by a local transcoder is inefficient in multimedia transcoding.

### SUMMARY

An aspect of embodiments described in the present disclosure is to provide an offline download method and a system thereof to solve low utilization of download servers in a traditional offline download system.

Another aspect of embodiments described in the present disclosure is to provide a multimedia file download method and a system thereof as a multimedia transcoding solution that improves transcoding efficiency.

In one aspect, embodiments described in the present disclosure provide an offline download system, including:

a download server cluster, where the download server cluster includes at least two download servers, each of which is configured to feed back load information to a distribution server according to its own load and obtain data information from the Internet according to an offline task;

the distribution server, configured to obtain the offline task, is communicatively connected with the download server cluster and configured to receive the load information, generate a scheduling rule according to the load information, and distribute the offline task to the download servers according to the scheduling rule; and

a storage server, communicatively connected with the download server cluster and configured to store the data information obtained by the download server cluster, and make the data information available for downloading.

Embodiments described in the present disclosure further include:

an offline task database, configured to store an original link of the offline task, where the download server cluster is communicatively connected with the offline task database and configured to obtain the original link of the offline task from the offline task database, and the download server cluster is further configured to write a portal address of data information corresponding to a completely downloaded offline task into the offline task database and generate a mapping record; and

an offline task manager, communicatively connected with the offline task database and the distribution server and configured to: judge according to the mapping record whether the offline task obtained by the distribution server is downloaded completely; if yes, provide the storage server directly with the data information of the completely downloaded offline task; if no, generate a unique sequence number for the offline task whose download is unfinished, write the sequence number and an original link of the offline task whose download is unfinished into the offline task database, and submit the offline task whose download is unfinished to the distribution server.

In some embodiments, the download servers are categorized into different types by download protocols, and the distribution server includes a task sorting module, where the task sorting module is configured to distribute the offline task to the download servers of corresponding types according to the download protocols.

In some embodiments, the distribution server includes a filtering module, where the filtering module is configured to compare the offline task with existing offline tasks, and filter out the offline task that already exists.

In some embodiments, the distribution server includes:

a load scheduling module, configured to receive the load information, generate a scheduling rule according to the load information, and maintain the scheduling rule and a link table that includes information on the download servers; and

a task distributing module, configured to distribute the offline task to the download servers according to the scheduling rule and the information in the link table.

In some embodiments, the load information includes CPU load, disk load, memory load, parallel queue length, and waiting queue length, and the scheduling rule is to allocate the offline task in inverse proportion to a real-time load of the download server, with the real-time load being expressed as:

F=a×CPU load+b×disk load+c×memory load+d×parallel queue length+e×waiting queue length, where

a, b, c, d, and e are weighting factors that range between 0 and 1, and F represents the real-time load.

In some embodiments, the system further includes a statistics server, configured to obtain download parameters of downloading the offline task, and generate logs according to the download parameters.

Embodiments described in the present disclosure provide an offline download method, including:

receiving load information fed back by each of download servers according to its own load;

obtaining an offline task;

generating a scheduling rule according to the load information of each download server, and distributing the offline task to the download servers according to the scheduling rule;

obtaining, by the download server to which the offline task is distributed, data information from the Internet according to the offline task, and storing the data information; and

providing the data information corresponding to the offline task so as to finish offline download.

In some embodiments, the step of obtaining data information from the Internet according to the offline task and storing the data information includes:

obtaining an original link of the offline task, and obtaining the data information according to the original link; and

storing the data information into a storage server synchronously, recording a portal address of storing the data information, and generating a mapping record.

In some embodiments, before the step of generating a scheduling rule according to the load information of each download server and distributing the offline task to the download servers according to the scheduling rule, the method further includes: distributing the offline task to the download servers of corresponding types according to download protocols.

In some embodiments, before the step of generating a scheduling rule according to the load information of each download server and distributing the offline task to the download servers according to the scheduling rule, the method further includes:

comparing the offline task with existing offline tasks, and filtering out the offline task that already exists.

In some embodiments, the step of generating a scheduling rule according to the load information of each download server and distributing the offline task to the download servers according to the scheduling rule includes:

generating a scheduling rule according to received load information, and maintaining the scheduling rule and a link table that includes information on the download servers; and

distributing the offline task to the download servers according to the scheduling rule and the information in the link table.

In some embodiments, the load information includes CPU load, disk load, memory load, parallel queue length, and waiting queue length, and the scheduling rule is to allocate the offline task in inverse proportion to a real-time load of the download server, with the real-time load being expressed as:

F=a×CPU load+b×disk load+c×memory load+d×parallel queue length+e×waiting queue length, where

a, b, c, d, and e are weighting factors that range between 0 and 1, and F represents the real-time load.

In some embodiments, after the step of providing the data information corresponding to the offline task so as to finish offline download, the method further includes: obtaining download parameters of downloading the offline task, and generating logs according to the download parameters.

In another aspect, embodiments described in the present disclosure provide a multimedia file download method, including:

obtaining, by a transcoding server, a transcoded file generated by transcoding a multimedia file; and

returning the transcoded file to a client according to a requirement of the client.

In some embodiments,

the obtaining, by a transcoding server, a transcoded file generated by transcoding a multimedia file, includes: transcoding, by the transcoding server beforehand, a video file that needs transcoding, and obtaining transcoded files of different code rates and different video formats and storing them in a transcoding aggregation result database; and

the returning the transcoded file to a client according to a requirement of the client includes: searching, by a video play format matching server when the client chooses to play a video file on demand, the transcoding aggregation result database for a transcoded file whose code rate and video format are suitable for playing on the client, and notifying the matched transcoded file to the client for playing on demand.

In some embodiments, the video files that need transcoding include: video files downloaded offline, and/or video files that are proactively scheduled by a transcoding scheduling server to the transcoding server for transcoding.

In some embodiments, the video files that are proactively scheduled by the transcoding scheduling server to the transcoding server for transcoding are: video files that have been downloaded a number of times more than a set threshold within a set time among the video files downloaded offline.

In some embodiments,

while or before the transcoding server transcodes beforehand the video file that needs transcoding, obtains transcoded files of different code rates and different video formats, and stores them in a transcoding aggregation result database, the method further includes:

aggregating, by a video aggregation analysis server, similar video files in the video files downloaded offline, and storing an aggregation result into the transcoding aggregation result database, where

correspondingly, when the client chooses to play a video file on demand, if the video play format matching server finds no transcoded file suitable for playing on the client in the transcoding aggregation result database, the video play format matching server recommends to the client another video file that is in an aggregated relationship with the video file chosen by the client for playing on demand, so as to make the client choose whether to play the recommended video file on demand.

In some embodiments,

the offline download system provided in any embodiment of the present invention is used to obtain data information of offline task download as the video file that needs transcoding.

In some embodiments, the notifying the matched transcoded file to the client for playing on demand includes:

obtaining and providing a video link, a video download address or a BT seed corresponding to the matched transcoded file for the client, so that the client adds the video link, the video download address or the BT seed and uses cloud-on-demand to enable click-to-play of the transcoded file.

In some embodiments, the transcoded file suitable for playing on the client is obtained by transcoding the video file chosen by the client for playing on demand, and has a code rate that matches bandwidth of the client and has a video format supported by the client.

In some embodiments, the returning the transcoded file to a client according to the requirement of the client includes:

obtaining an original multimedia identifier from the client;

searching for a transcoded multimedia identifier corresponding to the original multimedia identifier according to a stored mapping relationship between the original multimedia identifier and the transcoded multimedia identifier;

obtaining the transcoded file according to the transcoded multimedia identifier; and

returning the obtained transcoded file to the client.

In some embodiments, the obtaining the transcoded file according to the transcoded multimedia identifier includes:

obtaining basic information and a download address of the transcoded file corresponding to the transcoded multimedia identifier;

returning the obtained basic information and the download address to the client; and

obtaining the transcoded file chosen by the client.

In some embodiments, the basic information of the transcoded file includes format information of the transcoded file;

the method further includes: obtaining transcoding parameters of original multimedia from the client; and

the step of obtaining basic information and a download address of the transcoded file corresponding to the transcoded multimedia identifier and returning the basic information and the download address to the client includes:

searching for basic information of the transcoded file corresponding to the transcoded multimedia identifier, where the format information of the transcoded file matches the transcoding parameters of the original multimedia;

obtaining a download address of the transcoded file corresponding to the basic information; and

returning the basic information and the download address of the transcoded file corresponding to the basic information to the client.

In some embodiments, the obtaining, by a transcoding server, a transcoded file generated by transcoding a multimedia file, includes:

obtaining the original multimedia and transcoding parameters of the original multimedia, which are uploaded by the client; and

transcoding, by the transcoding server, the original multimedia according to the transcoding parameters of the original multimedia to obtain the transcoded file.

In some embodiments, the method further includes:

storing the transcoded file obtained through the transcoding;

obtaining the transcoded multimedia identifier, the basic information, the download address, and the original multimedia identifier corresponding to the transcoded multimedia; and

storing the original multimedia identifier, the transcoded multimedia identifier, the basic information, and the download address correspondingly.

In some embodiments, the identifier is an information digest value of multimedia.

In another aspect, embodiments described in the present disclosure provide a multimedia file download system, including:

a transcoding server, configured to obtain a transcoded file generated by transcoding a multimedia file; and

a file returning server, configured to return the transcoded file to a client according to a requirement of the client.

In some embodiments,

the system further includes a transcoding aggregation result database;

the transcoding server is specifically configured to transcode beforehand the video file that needs transcoding, obtain transcoded files of different code rates and different video formats, and store them in the transcoding aggregation result database;

the transcoding aggregation result database is configured to store each transcoded file obtained by the transcoding server; and

the file returning server is specifically a video play format matching server, and is configured to, in view of a video file chosen by the client for playing on demand, search the transcoding aggregation result database for a transcoded file whose code rate and video format are suitable for playing on the client, and notify the matched transcoded file to the client for playing on demand.

In some embodiments, the system further includes a transcoding scheduling server, configured to schedule video files that need transcoding to the transcoding server, where

the video files that need transcoding include: video files downloaded offline, and/or video files that are scheduled by the transcoding scheduling server to the transcoding server for transcoding.

In some embodiments, the video files that are scheduled by the transcoding scheduling server to the transcoding server for transcoding are video files that have been downloaded for a number of times more than a set threshold within a set time among the video files downloaded offline.

In some embodiments, the system further includes:

a video aggregation analysis server, configured to aggregate similar video files in the video files downloaded offline, and store an aggregation result into the transcoding aggregation result database, where

the video play format matching server is further configured to, if no transcoded file suitable for playing on the client is found, recommend to the client another video file that is in an aggregated relationship with the video file chosen by the client for playing on demand, so as to make the client choose whether to play the recommended video file on demand.

In some embodiments, the transcoded file suitable for playing on the client is obtained by transcoding the video file chosen by the client for playing on demand, and has a code rate that matches bandwidth of the client and has a video format supported by the client.

In some embodiments,

the system further includes a transcoding index database and a transcoded multimedia storage server;

the transcoding index database is configured to store a mapping relationship between an original multimedia identifier and a transcoded multimedia identifier;

the transcoded multimedia storage server is configured to store transcoded files;

the file returning server is specifically a transcoding task management server, and the transcoding task management server includes:

an information obtaining module, configured to obtain the original multimedia identifier from the client;

a searching module, configured to: search the transcoding index database for the transcoded multimedia identifier corresponding to the original multimedia identifier, and obtain the transcoded file from the transcoded multimedia storage server according to the transcoded multimedia identifier; and

a communication module, configured to return the obtained transcoded file to the client.

In some embodiments, the transcoding index database is further configured to store a mapping relationship between the transcoded multimedia identifier and basic information together with a download address of the transcoded file;

the searching module is specifically configured to search the transcoding index database for the transcoded multimedia identifier corresponding to the original multimedia identifier, and for the basic information and the download address of the transcoded file corresponding to the transcoded multimedia identifier; and

the communication module is specifically configured to return the basic information and the download address to the client, obtain the transcoded file chosen by the client, and return the transcoded file chosen by the client to the client.

In some embodiments, the basic information of the transcoded file includes format information of the transcoded file;

the information obtaining module is further configured to obtain transcoding parameters of original multimedia;

the searching module is specifically configured to search the transcoding index database for the transcoded multimedia identifier corresponding to the original multimedia identifier, and for the basic information of the transcoded file corresponding to the transcoded multimedia identifier and whose format information matches the transcoding parameters of the original multimedia, and obtain the download address of the transcoded file corresponding to the basic information; and

the communication module is specifically configured to return the basic information and the download address of the transcoded file corresponding to the basic information to the client, obtain the transcoded file chosen by the client, and return the transcoded file chosen by the client to the client.

In some embodiments, the information obtaining module is further configured to obtain the original multimedia and transcoding parameters of the original multimedia, which are uploaded by the client;

the transcoding server is specifically configured to transcode the original multimedia according to the transcoding parameters of the original multimedia;

the transcoded multimedia storage server is configured to store transcoded files generated as a result of transcoding by the transcoding server; and

the communication module is further configured to return the transcoded files generated as a result of transcoding to the client.

In some embodiments, the transcoding server is further configured to obtain the transcoded multimedia identifier, the basic information, the download address, and the original multimedia identifier corresponding to the transcoded file; and

the transcoding index database is configured to store a mapping relationship between the original multimedia identifier and the transcoded multimedia identifier obtained by the transcoding server, and a mapping relationship between the transcoded multimedia identifier and the basic information together with the download address.

In some embodiments, the identifier is an information digest value of multimedia.

The offline download method and the system thereof provided in the embodiments described in the present disclosure can schedule offline tasks according to the load of each download server to improve utilization of download servers. The multimedia file download method and the system thereof provided in the embodiments described in the present disclosure use a network-side transcoding server to transcode multimedia so as to save resources consumed by a client in transcoding the multimedia, and improve multimedia processing efficiency of the client.

### BRIEF DESCRIPTION OF DRAWINGS

FIG. 1 is a schematic structural diagram of an offline download system according to embodiments described in the present disclosure;

FIG. 2 is a detailed module diagram of a download server cluster in the offline download system shown in FIG. 1;

FIG. 3 is a detailed module diagram of a distribution server in the offline download system shown in FIG. 1;

FIG. 4 is a flowchart of an offline download method according to embodiments described in the present disclosure;

FIG. 5 is a flowchart of an offline download method according to embodiments described in the present disclosure;

FIG. 6 is a flowchart of an offline download method according to embodiments described in the present disclosure;

FIG. 7 is a schematic structural diagram of an offline download system according to embodiments described in the present disclosure;

FIG. 8 is a structural diagram of a cloud-on-demand system based on offline download according to embodiments described in the present disclosure;

FIG. 9 is a flowchart of a multimedia file download method according to embodiments described in the present disclosure;

FIG. 10 is a flowchart of a multimedia file download method according to embodiments described in the present disclosure;

FIG. 11 is a flowchart of a multimedia file download method according to embodiments described in the present disclosure;

FIG. 12 is a flowchart of a multimedia file download method according to embodiments described in the present disclosure;

FIG. 13 is a flowchart of a multimedia file download method according to embodiments described in the present disclosure;

FIG. 14 is a flowchart of a multimedia file download method according to embodiments described in the present disclosure;

FIG. 15 is a schematic structural diagram of a multimedia download system according to embodiments described in the present disclosure; and

FIG. 16 is a schematic structural diagram of a multimedia download system according to embodiments described in the present disclosure.

### DETAILED DESCRIPTION

To make the objectives, technical solutions, and advantages of embodiments described in the present disclosure more comprehensible, the following clearly and thoroughly describes the technical solutions with reference to the accompanying drawings. The embodiments described in the present disclosure are part rather than all of the possible embodiments. Other embodiments obtained by persons of ordinary skill in the art based on the embodiments described in the present disclosure shall fall within the protection scope of the present disclosure.

A network download service is not only capable of downloading multimedia video files, but also capable of downloading various resource data such as software, pictures, books, and so on. Cloud-side subscribed downloading, also referred to as offline downloading, saves download resources of the user equipment. Offline download tools include a server and a client, where the server pre-downloads the file in place of the client configured on the user equipment. For example, a resource is unpopular and the speed of downloading the resource is very low, such that it takes a long time for the client of the user equipment to download the resource. If the user applies the offline download technology, the server configured by the service provider can download the resource in place of the user's client, and the user can turn off the local client of the download tool or power off the user device, which saves time and electricity. After the server finishes the offline download, the user downloads the resource from the server of the download tool to the computer user equipment on the client side at a high speed. Offline download saves time, and more importantly, the bandwidth of the computer user equipment can be vacated for other tasks. The offline download provides a network acceleration service by letting a server perform the download operation by proxy at a high speed, transferring the downloaded resource to an offline space, and then letting the user download the resource from an offline download server to a local client.

One procedure of cloud-side subscribed downloading is: a user submits a subscription request that carries a file download address of a file to be downloaded; an offline task management server receives the subscription request submitted by the user; after receiving the subscription request, the offline task management server queries mapping records in a database, and checks whether a file corresponding to the subscription request is being downloaded or has been downloaded completely on the server cloud side, and, if so, notifies the client directly, and then the client can download from the server cloud side directly and use a P2SP (point to server and point) technology; if no appropriate file is matched on the server, an offline task request is sent to an offline task distribution server; the offline task distribution server uses configuration files to manage download servers, and schedules offline tasks according to an initial byte interval of a download link Hash (the Hash is a process of converting an input of any length into an output of a fixed length through a Hash algorithm, where the output is a Hash value) generated through Hash calculation of the file download address, and the offline tasks are scheduled to an offline download server cluster; the offline download server cluster starts downloading data information from the Internet according to the file download address that is in the form of a URL (Uniform/Universal Resource Locator, also called a webpage address); the downloaded data information is synchronized to a cloud-side storage server, and the download result is written into a database at the same time.

In an offline download system, the offline task distribution groups offline tasks according to a range of the initial byte interval of the download link Hash. However, users' download requirements and sizes of files to be downloaded are distributed very unevenly, which leads to uneven loads distributed to the download servers in the offline download server cluster. The download server works by means of P2P (point to point) software. That is, each download server performs download to the best of its ability. Therefore, both data sources from which data fragments are obtained and disks into which the data fragments are written are random and irregular. The I/O of the download server tends to be a bottleneck of the download system. Some systems group tasks randomly according to the download link Hash and allocate the tasks to the download server in the corresponding group, and the actual effect is still that the disk I/O of some download servers become a system bottleneck, where the offline tasks have to queue up, and the download cannot be completed in time. Also, due to characteristics of a P2SP (point to server and point) network, the download by a download server is uncertain, and it is difficult to predict whether the download can be finished and when the download will be complete, which makes it difficult to determine how the disks of the download server are actually utilized and how to perform allocation.

Often, in an offline download system, the download server is lowly utilized and the disk space is not utilized efficiently.

In an offline download system, the number of distribution servers is different from the number of download servers that actually perform download operations. The number of download servers varies with the download requirements. Currently, configuration files are used on the distribution server to manage the download servers, which brings inconvenience to expansion deployment and upgrade of the download servers and leads to low utilization of download servers. In view of the foregoing problems, embodiments described in the present disclosure provide an offline download system and an offline download method to solve low utilization of offline download servers in an offline download process.

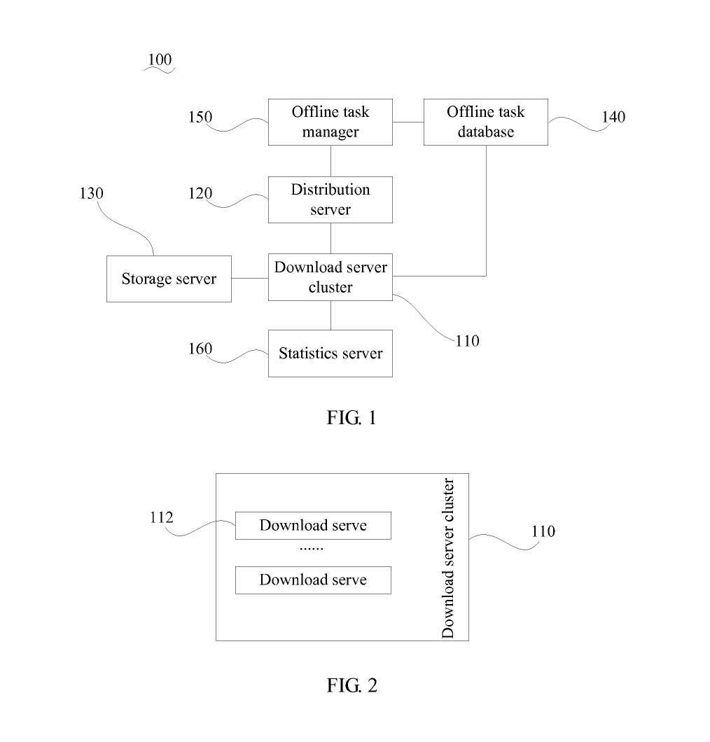

FIG. 1 is a schematic structural diagram of an offline download system according to embodiments described in the present disclosure. As shown in FIG. 1, the offline download system 100 includes a download server cluster 110, a distribution server 120, and a storage server 130. The offline download system 100 is configured to provide an offline download service for a client. The client is generally operated by a user, and may be in the form of computer hardware or software. A software client may run on user equipment.

FIG. 2 is a detailed module diagram of a download server cluster 110 in the offline download system shown in FIG. 1. As shown in FIG. 2, the download server cluster 110 specifically includes at least two download servers 112, and each download server 112 is configured to feed back load information according to its own load and obtain data information from the Internet according to an offline task. The data information is a file to be downloaded, for example, a multimedia file. The download servers 112 may be categorized into different types by download protocols. In this embodiment, the download protocols include Bt (bit torrent), eMule (electronic mule), and Http (Hyper Text Transfer Protocol). Correspondingly, there are three types of download servers 112 that match the above three download protocols.

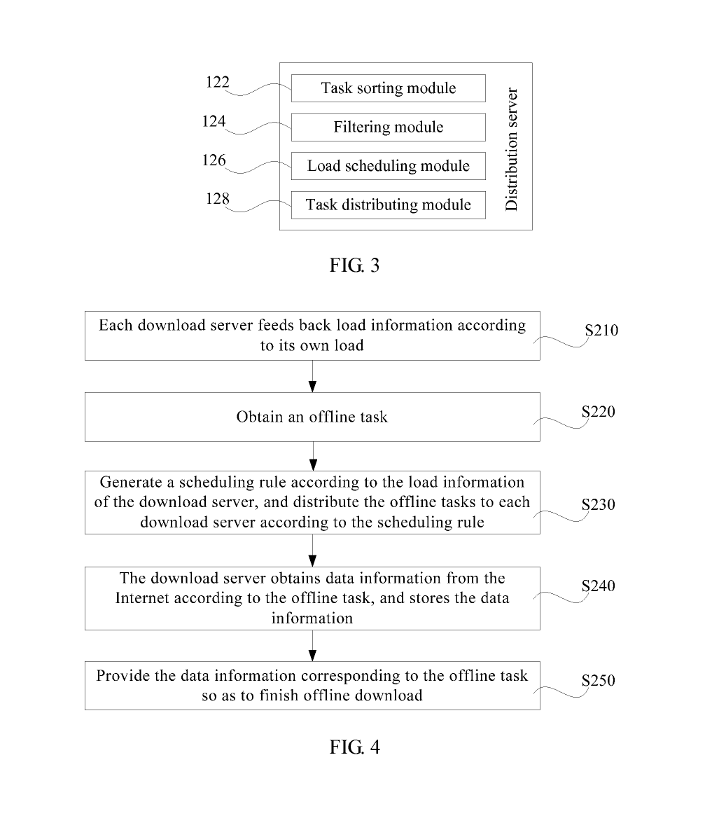

As shown in FIG. 1, the distribution server 120 is communicatively connected with the download server cluster 110, and is configured to obtain the offline task. The offline task may be obtained from multiple sources, for example, generated when the client submits an offline task download request. As shown in FIG. 3, the distribution server 120 may specifically include a task sorting module 122, a filtering module 124, a load scheduling module 126, and a task distributing module 128.

The task sorting module 122 is configured to distribute the obtained offline task to the download servers 112 of corresponding types according to download protocols. For example, to avoid download failure, the task sorting module 122 allocates an offline task that supports the Bt download protocol to the download server 112 corresponding to the Bt download protocol rather than another download server 112 of an inappropriate type.

The filtering module 124 is configured to compare the obtained offline task with existing offline tasks, and filter out the offline task that already exists. That is, for the same offline task, the download request is sent to the download server cluster 110 only once; if multiple different users send download requests for the same offline task, such different users can share the common offline task.

The load scheduling module 126 receives load information fed back by the download servers 112, and generates a scheduling rule according to the load information. For example, the load scheduling module 126 may receive respective load information that is fed back by each download server 112 respectively, or receive the load information fed back by the download server 112 that needs to feed back. The load scheduling module 126 maintains the scheduling rule and a link table that includes the information on each download server 112. In some embodiments, the load information includes CPU load, disk load, memory load, parallel queue length, and waiting queue length. Elements in the link table are information on each download server 112, and can include IP address, port, download server identifier (server ID), last report time (lastReportTime), and real-time load. The load scheduling module 126 updates the link table according to the load information fed back by the download server 112. In some embodiments, the download server 112 feeds back the load information in the form of heartbeat packets. The heartbeat packets can be sent every 10 seconds to ensure latest information in the link table.

The task distributing module 128 distributes the offline task to the download servers 112 according to the scheduling rule and the information in the link table. In some embodiments, the scheduling rule is to allocate the offline task in inverse proportion to a real-time load of the download server 112. The real-time load is expressed as:

F=a×CPU load+b×disk load+c×memory load+d×parallel queue length+e×waiting queue length, where

a, b, c, d, and e are weighting factors that range between 0 and 1, and F represents the real-time load.

As shown in FIG. 1, the storage server 130 is communicatively connected with the download server cluster 110 and configured to store the data information obtained by the download server cluster 110, and make the data information available to the client for downloading.

The offline download system 100 further includes an offline task database 140, an offline task manager 150, and a statistics server 160.

The offline task database 140 is configured to store an original link of the offline task. The download server cluster 110 is communicatively connected with the offline task database 140, and obtains the original link of the offline task from the offline task database 140. The download server cluster 110 writes a portal address of the data information corresponding to a completely downloaded offline task into the offline task database 140, and generates a mapping record. The mapping record may record the download status of the offline task, for example, downloading, downloaded, or suspended, and record the portal address of the data information corresponding to the offline task.

The offline task manager 150 is communicatively connected with the offline task database 140 and the distribution server 120. The offline task manager 150 judges according to the mapping record whether the offline task is downloaded completely; if yes, provides the data information directly; if no, generates a unique sequence number for the offline task whose download is unfinished, writes the sequence number and an original link of the offline task into the offline task database 140, and submits the offline task whose download is unfinished to the distribution server 120.

The statistics server 160 obtains download parameters of downloading the offline task, and generates logs according to the download parameters. In some embodiments, the download parameters may include download speed of URL (web address), download time, network connectivity, download result, and file size in the download process. The generated logs are available for future statistics and analysis.

The functions of the offline download system 100 are implemented in the following procedure:

The load scheduling module 126 manages heartbeat and logout of the download server 112 and receives its load information. The load scheduling module 126 transfers information on the download servers 112 to the task distributing module 128 by means of a dual buffer. When the load scheduling module 126 writes data into a first buffer, the task distributing module 128 reads data from a second buffer. After the load scheduling module 126 finishes writing, the task distributing module 128 starts reading the data from the first buffer, and the load scheduling module 126 writes the data into the second buffer. The load scheduling module 126 maintains a link table. Each element in the link table is information on each download server 112, including IP address, port, download server identifier (server ID), last report time (lastReportTime), and real-time load, where the server ID is a 64-bit signless integer, the IP resides in higher bytes, and the port resides in lower bytes. The load scheduling module 126 then performs a hash index for the elements of the link table, using server ID as a key. In this way, when choosing a download server according to the elements in the link table, the task distributing module 128 can have a quick index to a specific element while keeping a traverse order.

The operations of the download server 112 sending a heartbeat packet to the load scheduling module 126 to report the load information are as follows:

The download server 112 sends a heartbeat packet to the load scheduling module 126, with the heartbeat packet carrying the load information. The heartbeat packet may be sent every 10 seconds. When receiving the heartbeat packet, the load scheduling module 126 searches a download server information set (server Info Set) to check whether download server information (server Info) exists, for example, by traversing the link table, and, if not, inserts a new piece of download server information (server Info), or, if the download server information exists, checks whether the new load information in the heartbeat packet is different from original load information of the download server. If they are different, a flag is affixed to indicate that there is different load information. When the load scheduling module 126 communicates with the task distributing module 128 next time, the load information of the download server can be updated. If overload information (for example, the disk load is greater than 85%, and the disk space, the CPU, the memory, the parallel queue length, or the waiting queue length exceeds a threshold) appears in the new load information, the overload information needs to be notified to the task distributing module 128 immediately.

The operations of the download server 112 logging out of the load scheduling module 126 include:

When receiving a download server logout request, the load scheduling module 126 deletes the download server information on the download server corresponding to the logout request from the download server information set, sets a flag of needing to update the shared memory, and notifies the task distributing module 128 immediately.

The operations of handling heartbeat packet timeout of the download server 112 include:

The load scheduling module 126 traverses the download server information set every 10 seconds, deletes the download server 112 with a timed-out heartbeat packet from the download server information set, sets a flag of needing to update the shared memory, and updates the information on the download server at update time in the next update period.

The operations of communication between the load scheduling module 126 and the task distributing module 128 are as follows:

At the time of update, the load scheduling module 126 writes all data in the download server information set into a buffer, and then, by setting a flag in the buffer, instructs the task distributing module 128 to read data from the buffer. The update may occur when overload information appears in the load information of the download server 112 or when the download server logs out. Also, the update may occur after the download servers 112 with heartbeat packet timeout are cleared every 10 seconds, and the need of update is checked. If update is required, the task distributing module 128 is notified. Therefore, normally, the load scheduling module 126 communicates with the task distributing module 128 every 10 seconds. In a major cycle, the task distributing module 128 checks the flag in the buffer, and, if the flag is true, reads information on the download server 112 from the buffer.

Scheduling is implemented in the following way:

Based on an initial byte interval of a download link Hash, the distribution server performs scheduling according to a capability ratio decided by the load information of the download server 112. If an allocation ratio of a download server 112 is set to 0, the distribution server schedules no more offline tasks to this download server for downloading. For example, a current scheme is to allocate tasks according to initial bytes (0-255) of the download link Hash, and four download servers A, B, C, and D are currently available.

A default scheduling and allocation rule is random allocation, for example, 25% of (0-255) is allocated to A, and it is the same with B, C, and D. The corresponding scheduling rule is:

A 0-63

B 64-127

C 128-192

D 193-255

When a fifth download server 112—machine (E) logs in, if its load weight is ignored, 20% of the offline tasks is allocated to each download server 112, and the corresponding scheduling rule changes to:

A 0-51

B 52-101

C 102-153

D 154-204

E 205-255

Upon timeout of the heartbeat packet of one of the download servers 112, deregistration occurs, that is, the download server needs to log out. Therefore, no new offline tasks will be added to the download server 112, and the 5 servers decrease to 4 servers. On this occasion, the load scheduling module 126 may calculate the real-time load of each download server 112 according to the load information, and update the link table maintained by it. The task distributing module 128 reads link table information from the load scheduling module 126, and schedules tasks according to the scheduling rule. The real-time load is expressed as:

F=a×CPU load+b×disk load+c×memory load+d×parallel queue length+e×waiting queue length, where

a, b, c, d, and e are weighting factors that range between 0 and 1, and F represents the real-time load.

Each download server reports a value to the task distributing module 128 according to the same rule, where the value identifies the current load capability of the server, and a greater value means a smaller current load capability. The task distributing module 128 performs scheduling in inverse proportion to the current load capability of each download server. If the current load capability of a download server is 0, no offline task will be scheduled onto the download server.

Alternatively, the task distributing module 128 may, at the very beginning, schedule the offline tasks to each download server based on the load information.

FIG. 4 is a flowchart of an offline download method according to embodiments described in the present disclosure. As shown in FIG. 4, the offline download method includes steps S210-S250, as detailed below:

Step S210: Each download server feeds back load information according to its own load.

In some embodiments, the load information of the download server 112 includes CPU load, disk load, memory load, parallel queue length, waiting queue length, and so on. The download server 112 may feed back the load information in the form of heartbeat packets. The heartbeat packets may be sent every 10 seconds. Understandably, the load information is not limited to the items listed above, and corresponding parameters may be selected as load information according to actual conditions of the download server. Also, the time interval of sending the heartbeat packets is not limited to 10 seconds. Shorter intervals mean faster update of the load information, and the intervals in a specific range are enough to meet requirements. All download servers feed back the load information at set intervals, or a download server feeds back the load information only when it discovers change of its load information.

Step S220: Obtain an offline task.

The offline task may be provided when a user uses the offline download system, and Offline tasks may include various types such as video, audio, and text. According to download protocols, offline tasks may be categorized into three types based on download protocols such as Bt, eMule, and Http. A distribution server may obtain offline tasks from an offline task download request sent by a user.

Step S230: Generate a scheduling rule according to the load information of the download server, and distribute the offline task to the download servers according to the scheduling rule.

Step S240: The download server obtains data information from the Internet according to the offline task, and stores the data information.

After obtaining the offline task, the download server may obtain data information from the Internet. After the data information is obtained, because the data information is not taken away immediately by the user, the data information is generally stored in a storage server to avoid repeated download in the future.

Step S250: Provide the data information corresponding to the offline task so as to finish offline download.

When the user needs to download the data information corresponding to the offline task, the data information is searched out first according to an index and a Hash result, and then a portal address of storing the data information is read and fed back to the user. The user can download the desired data information according to the portal address. If no corresponding Hash result is found, it indicates that the offline task has not been downloaded completely, and the foregoing offline download method may be performed to obtain the data information and then provide it for the user.

After the steps of offline download are complete, a step of obtaining download parameters of downloading the offline task and generating logs according to the download parameters may be performed. In some embodiments, the download parameters include download speed of URL, download time, network connectivity, download result, and file size in the download process. It should be pointed out that this step is intended only to generate logs available for future statistics and analysis, without posing any impact on completion of the offline download.

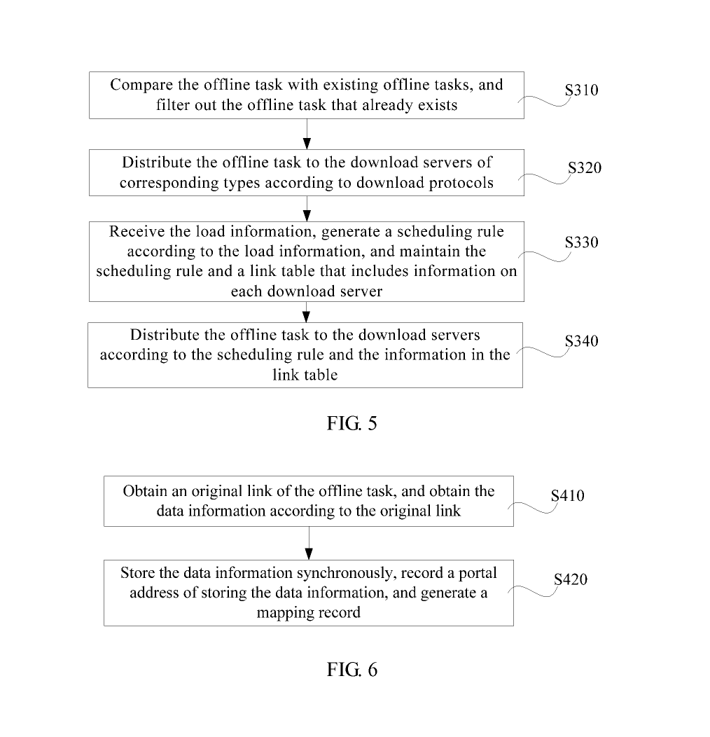

FIG. 5 is a flowchart of an offline download method according to embodiments described in the present disclosure. Embodiments of FIG. 5 are based on embodiments of FIGS. 1-4, where the process of generating a scheduling rule according to the load information of the download server and distributing the offline task to the download servers according to the scheduling rule may include:

Step S310: Compare the offline task with existing offline tasks, and filter out the offline task that already exists.

That is, the currently obtained offline task is compared with existing offline tasks, and the existing offline tasks may include offline tasks that have been downloaded completely and offline tasks that are being downloaded. If an offline task already exists, the offline task is filtered out, without being distributed to the download server. That is, for the same offline task, the download request is sent to the download server cluster 110 only once; if multiple different users send download requests for the same offline task, such different users can share the common offline task.

Step S320: Distribute the offline task to the download servers of corresponding types according to download protocols.

As mentioned in step S220, the obtained offline tasks may be based on download protocols such as Bt, eMule, and Http. The offline tasks of different types need to be distributed to the download servers 112 of corresponding types to prevent download errors.

Step S330: Receive the load information, generate a scheduling rule according to the load information, and maintain the scheduling rule and a link table that includes information on each download server.

Elements in the link table are information on the download server 112, and include IP address, port, download server identifier (server ID), last report time (lastReportTime), and real-time load. The link table is updated according to the load information fed back by the download server 112. In some embodiments, the scheduling rule is to allocate the offline tasks in inverse proportion to a real-time load of the download server.

The real-time load is expressed as:

F=a×CPU load+b×disk load+c×memory load+d×parallel queue length+e×waiting queue length, where

a, b, c, d, and e are weighting factors that range between 0 and 1, and F represents the real-time load.

Step S340: Distribute the offline task to the download servers according to the scheduling rule and the information in the link table.

Read data in the link table, obtain the information on the registered download server 112, and allocate the offline tasks according to the real-time load of each download server 112. The process includes: Obtain the real-time load of each download server 112 by traversing the information in the link table, calculate the offline tasks that should be allocated to each download server according to the scheduling rule, map the calculation result to the IP of the download server 112, and then distribute the offline download tasks to the download server 112 accurately according to the IP address of the download server 112.

In the steps above, steps S310 and S320 are optional. In step S320, distributing the offline task to the download servers of corresponding types may be: first, determining the download server of the type corresponding to an offline task, and then, in step S330, generating a scheduling rule according to the load information of the download server of the corresponding type, and distributing the offline task to the download server of the corresponding type.

FIG. 6 is a flowchart of an offline download method according to embodiments described in the present disclosure. As shown in FIG. 6, embodiments of FIG. 6 are based on embodiments of FIGS. 1-5, and step S240 may be:

Step S410: Obtain an original link of the offline task, and obtain the data information according to the original link.

Each offline task has an original link. When an offline task is obtained, a unique sequence number is allocated to the offline task, and the sequence number and the original link are stored in an offline task database. After obtaining the allocated offline task, the download server 112 searches the offline task database for the corresponding original link according to the sequence number of the offline task.

Step S420: Store the data information synchronously, record a portal address of storing the data information, and generate a mapping record.

After an offline task is downloaded completely, the corresponding data information is stored by the download server into a storage server 130 synchronously. To facilitate lookup of the data information, each piece of downloaded data information has a unique index. In some embodiments, the index is specifically a Hash result of the download address.

The detailed implementation process of the offline download method is similar to the process of implementing the functions of the offline download system 100, and is not repeated here any further.

The offline download system 100 includes a distribution server 120, each download server 112 feeds back its load information to the distribution server 120, and the distribution server 120 generates a scheduling rule according to actual load information of the download server 112 and allocates the offline task according to the scheduling rule. To a heavy-loaded download server 112, few or no task is distributed; to a light-loaded download server 112, more tasks are distributed. Therefore, the tasks distributed to a download server 112 depend on the extent of its real-time load, thereby improving utilization of the download servers 112 and making full use of disk spaces.

Overall, the embodiments described in the present disclosure provide an offline download system and an offline download method.

An offline download system includes:

a download server cluster, where the download server cluster includes at least two download servers, each of which feeds back load information according to its load and obtains data information from the Internet according to an offline task;

a distribution server, which obtains the offline task, communicates with the download server cluster, receives the load information, generates a scheduling rule according to the load information, and distributes the offline task to the download servers according to the scheduling rule; and

a storage server, communicatively connected with the download server cluster and configured to store the data information obtained by the download server cluster, and make the data information available for downloading.

The offline download system further includes:

an offline task database, configured to store original link of the offline task, where the download server cluster is communicatively connected with the offline task database and configured to obtain the original link of the offline task from the offline task database, and the download server cluster is further configured to write a portal address of data information corresponding to a completely downloaded offline task into the offline task database and generate a mapping record; and an offline task manager, communicatively connected with the offline task database and the distribution server and configured to: judge according to the mapping record whether the offline task is downloaded completely; if yes, provide the data information directly; if no, generate a unique sequence number for the offline task, write the sequence number and an original link of the offline task into the offline task database, and submit the offline task to the distribution server.

Further, the download servers are categorized into different types by download protocols, and the distribution server includes a task sorting module, where the task sorting module distributes the offline task to the download servers of corresponding types according to the download protocols.

Further, the distribution server includes a filtering module, where the filtering module compares the offline task with existing offline tasks, and filters out the offline task that already exists.

Further, the distribution server includes:

a load scheduling module, configured to receive the load information, generate a scheduling rule according to the load information, and maintain the scheduling rule and a link table that includes information on the download servers; and

a task distributing module, configured to distribute the offline task to the download servers according to the scheduling rule and the information in the link table.

Further, the load information includes CPU load, disk load, memory load, parallel queue length, and waiting queue length, and the scheduling rule is to allocate the offline task in inverse proportion to a real-time load of the download server, with the real-time load being expressed as:

F=a×CPU load+b×disk load+c×memory load+d×parallel queue length+e×waiting queue length, where

a, b, c, d, and e are weighting factors that range between 0 and 1, and F represents the real-time load.

The system further includes a statistics server, which obtains download parameters of downloading the offline task, and generates logs according to the download parameters.

Further, the embodiment of the present invention provides an offline download method, and the method includes the following steps:

feeding back, by a download server, load information according to its load;

obtaining an offline task;

generating a scheduling rule according to the load information of each download server, and distributing the offline task according to the scheduling rule;

obtaining data information from the Internet according to the offline task, and storing the data information; and

providing the data information corresponding to the offline task so as to finish offline download.

Further, the step of obtaining data information from the Internet according to the offline task and storing the data information includes:

obtaining an original link of the offline task, and obtaining the data information according to the original link;

storing the data information synchronously, recording a portal address of storing the data information, and generating a mapping record.

Further, before or in the process of the step of generating a scheduling rule according to the load information of the download server and distributing the offline task according to the scheduling rule, the method further includes: distributing the offline task to the download servers of corresponding types according to download protocols.

Further, the step of generating a scheduling rule according to the load information of the download server and distributing the offline task according to the scheduling rule includes:

comparing the offline task with existing offline tasks, and filtering out the offline task that already exists.

Further, the step of generating a scheduling rule according to the load information of the download server and distributing the offline task according to the scheduling rule includes:

receiving the load information, generating a scheduling rule according to the load information, and maintaining the scheduling rule and a link table that includes information on the download server; and

distributing the offline task to the download servers according to the scheduling rule and the information in the link table.

Further, the load information includes CPU load, disk load, memory load, parallel queue length, and waiting queue length, and the scheduling rule is to allocate the offline task in inverse proportion to a real-time load of the download server, with the real-time load being expressed as:

F=a×CPU load+b×disk load+c×memory load+d×parallel queue length+e×waiting queue length, where

a, b, c, d, and e are weighting factors that range between 0 and 1, and F represents the real-time load.

Further, after the step of providing the data information corresponding to the offline task so as to finish offline download, the method includes: obtaining download parameters of downloading the offline task, and generating logs according to the download parameters.

The offline download system includes a distribution server, the download server feeds back its load information to the distribution server in real time, and the distribution server generates a scheduling rule according to actual load information of the download server and allocates the offline task according to the scheduling rule. To a heavy-loaded download server, few or no task is distributed; to a light-loaded download server, more tasks are distributed. Therefore, the tasks distributed to a download server depend on the extent of its real-time load, thereby improving utilization of the download server and making full use of disk spaces.

Embodiments described in the present disclosure further provide a multimedia file download method, including: obtaining, by a transcoding server, a transcoded file generated by transcoding a multimedia file; and returning the transcoded file to a client as according to a requirement of the client.

Embodiments described in the present disclosure further provide a multimedia file download system, including a transcoding server and a file returning server. The transcoding server is configured to obtain a transcoded file generated by transcoding a multimedia file; and the file returning server is configured to return the transcoded file to a client as according to a requirement of the client.

In the multimedia file download method and the system thereof, the transcoding server set on the network side transcodes multimedia in a manner that meets requirement of the client, and can return the transcoded file to the client according to the requirement of the client, thereby saving resources consumed by the client for transcoding the multimedia files. Moreover, the transcoded files are usually reusable, which avoids resource waste caused by repeated transcoding on the client.

The multimedia download solution is applicable to multiple application scenarios. For example, the downloaded multimedia may be pictures, audio or video files. Typically, the solution is applicable to video file download.

Besides, the transcoding performed according to the requirement of the client may be: multiple typical client requirements are preset empirically, and transcoding is performed beforehand according to requirements of multiple clients to obtain transcoded files, and then, when a client requests a multimedia file, the preset client requirement that matches the actual requirement of the client is found, and a transcoded file is selected according to the matched requirement. In this solution, the transcoding is performed beforehand, which makes it faster for the client to obtain the transcoded file.

Alternatively, the requirements of the client are obtained in real time according to a multimedia file obtaining request sent by the client. For example, the requirements specify a display type supported by the user equipment that hosts the client, and require collecting of the bandwidth of the client and the network, and then the transcoding operation is performed in real time according to the requirements, and the transcoded file is returned to the client. The merits of this solution are that the transcoding is performed according to real-time requirements of the client, which makes the transcoded file better match the client requirements.

The multimedia file download method is applicable to multiple application scenarios, and typically, applicable to a video-on-demand scenario, VOD for short. Just as its name implies, video-on-demand is a VOD system that plays a program as required by a user, that is, transmits a video file clicked or chosen by the user to the requesting user. In the video-on-demand, the client initiates a video-on-demand connection proactively, and the user chooses to start, stop, back, fast-forward, or pause a video while putting through the video-on-demand connection.

The following expounds the multimedia file download method and the system thereof with reference to instances.

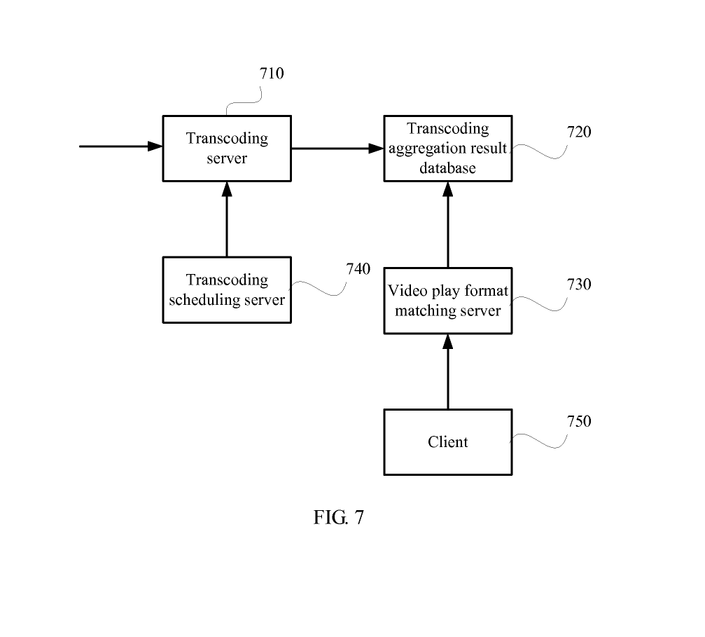

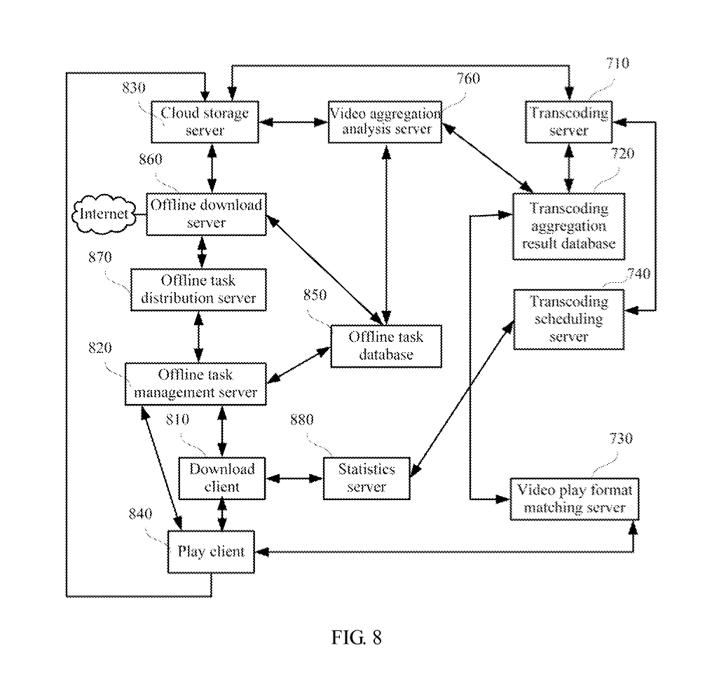

A multimedia file download system is introduced into the offline download system. The multimedia file download system is also called a transcoding system. The transcoding system may include a transcoding server 710, a transcoding aggregation result database 720, and a video play format matching server 730, as shown in FIG. 7.

The transcoding server 710 is configured to transcode beforehand a video file that needs transcoding, obtain transcoded files of different code rates and different video formats, and store them in the transcoding aggregation result database 720. The transcoding aggregation result database 720 is configured to store each transcoded file obtained by the transcoding server 710. The file returning server may be the video play format matching server 730, and is configured to: in view of a video file chosen by a client 750 for playing on demand, search the transcoding aggregation result database 720 for a transcoded file whose code rate and video format are suitable for playing on the client 750, and notify the matched transcoded file to the client 750 for playing on demand.

In some embodiments, the video files transcoded by the transcoding server may come from two sources: one source is video files downloaded offline, and the transcoding operations performed to such video files generate transcoded files of different code rates, which, for example, correspond to a super-definition mode, a high-definition mode, and a standard-definition mode of the client respectively, and such video files may be obtained in response to offline task download requests submitted by the client; the other source is video files that have been downloaded by users for a number of times more than a set threshold within a set time among the video files downloaded offline as counted by the offline download system, where the set time may be per day, and, the video files that have been downloaded by users for a number of times more than a set threshold within a set time such as per day may be called hot video files. Such hot video files may be determined according to statistics about the count of downloads performed by a specific user, or by certain user groups, or by all users.

The video files downloaded offline may be obtained by the transcoding server 710 proactively from the offline download system, and the hot video files may be obtained by the transcoding server 710 passively. Here, to ensure the transcoding server 710 to obtain the hot video files, the transcoding system shown in FIG. 7 further includes a transcoding scheduling server 740. The transcoding scheduling server 740 is configured to obtain the hot video files, and schedule them to the transcoding server 710 which then transcodes the hot video files.

That is, the video files that need transcoding may include: video files downloaded offline, and/or video files that are scheduled by the transcoding scheduling server to the transcoding server for transcoding. Preferably, the video files that are scheduled by the transcoding scheduling server to the transcoding server for transcoding are: video files that have been downloaded for a number of times more than a set threshold within a set time among the video files downloaded offline.

In some embodiments, each transcoded file stored in the transcoding aggregation database and the original video file corresponding to the transcoded file are identified respectively. Here, a Hash value may be used to identify the file stored in the transcoding aggregation database, and a transcoded file with a different code rate or video format has a different Hash value even if it is transcoded from the same original video file. Therefore, the transcoding aggregation database includes a mapping table, and the mapping table includes Hash values of original video files and Hash values of transcoded files, where the Hash value of a transcoded file includes the code rate and the video format of the transcoded file.

Therefore, in some embodiments, when choosing a video file for playing, the client may send the Hash value of the video file and an available bandwidth of the client to the video play format matching server. The video play format matching server searches the mapping table for the Hash value of the received video file, and, in the transcoded file Hash values corresponding to the found video file Hash value, finds a transcoded file Hash value with a code rate matching the available bandwidth of the client and with a video format supported by the client, and determines a transcoded file corresponding to the found transcoded file Hash value as the transcoded file suitable for playing on the client.

As revealed in the above description, when a client needs to play a video file in an offline space, because the video file has been transcoded and has a code rate that matches the client, the rate of the video-on-demand play is improved significantly.

Also, in some embodiments, to prevent piracy and transfer, a custom file header may be added in the transcoded file. For example, a digital signature is affixed through a private key of the server. In this way, when the client plays the transcoded file on demand, the correct file header is not available and the file is not playable unless the signature is authenticated successfully.

Also, in some embodiments, numerous similar video files exist in the offline space. To save storage of the offline space and improve the matching ratio of the transcoded file, the transcoding system shown in FIG. 7 may further include a video aggregation analysis server, configured to aggregate similar video files in the video files downloaded offline, and store an aggregation result into the transcoding aggregation result database. Therefore, when finding no transcoded file that meets the conditions, the video play format matching server recommends to the client another video file that is in an aggregated relationship with the video file chosen by the client for playing on demand, so that the client chooses whether to play the recommended video file on demand.

Described above is the system shown in FIG. 7. The following expounds the system shown in FIG. 7.

FIG. 8 is a structural diagram of a cloud-on-demand system. As shown in FIG. 8, the cloud-on-demand system may be composed of the offline download system and the transcoding system provided in embodiments described in the present disclosure, and may include 13 function modules, which are described below one by one:

1. Download client 810:

(1) The download client 810 is configured to request an offline task management server 820 to download a video file, and submit an offline task to the offline task management server 820, where the offline task may carry a download address of the video file to be downloaded, for example, carry a Url, an eMule link, a Bt seed, or a Magnet link. Embodiments described in the present disclosure do not restrict the form of the download address of the file.

(2) The download client 810 is further configured to: through the offline task management server 820, query download progress of the video file scheduled for downloading.

(3) The download client 810 is further configured to instantly download the video file from a cloud storage server 830 directly after the video file scheduled for downloading has been downloaded offline completely. The cloud storage server 830 is the storage server in the offline download system described earlier above.

2. Play client 840: The play client is of great concern in the present invention. The client in the transcoding system shown in FIG. 7 is the play client 840, and performs the following operations:

(1) The play client 840 may be configured to drag and drop a video file in a corresponding offline space, and display and deliver the video file chosen by the user to the user.

(2) The play client 840 requests the video play format matching server 730 to search out a transcoded file corresponding to the demanded video file for playing. According to a Hash value of a demanded original video file, the play client 840 searches in transcoded files that are stored in the video play format matching server 730 and generated by transcoding the original video file, so as to obtain and play a transcoded file that has a code rate matching the bandwidth of the play client and has a video format supported by the play client 840. The detailed process of playing the transcoded file on demand is: using the download client 810 to download a specific part of the transcoded file, parsing the structure of the transcoded file to obtain a start point and an end point of the specific part to be downloaded, and parsing the structure of the transcoded file to separate audio-video packets and decode the audio-video packets; and displaying and playing the decoded audio-video data, and playing the file.

(3) The play client 840 interacts with the user, and responds to the user's request for operating the video file.

(4) The play client 840 may be encapsulated as an Axtive component and installed in a browser to play videos, or a Flash player of the browser is invoked directly to play the file transcoded into an MP4 format. MP4 is a format of excellent performance as a whole, and is supported by a majority of browsers (Flash Player 9u3 or a later version needs to be installed), which makes it possible to extend to web-on-demand. Therefore, in some embodiments, MP4 may be chosen as a transcoding container format. For a play link submitted on the web side, no client needs to be installed, and a Flash supported by the browser is used to play the file directly.

3. Offline task database 850:

(1) The offline task database 850 is configured to store offline tasks in an offline task list. The user submits offline tasks through the offline task management server 820, and the offline tasks are stored in the offline task database 850.

(2) The offline task database 850 is further configured to store final status of completion of downloading an offline task. Upon completion of downloading an offline task, the offline download server 860 synchronizes data information of the offline task to a cloud storage server 830, and the synchronization result is written into the offline task database 850. For example, the status of completing the offline task and the portal of the data information in the cloud storage server 830 are written into the offline task database 850.

(3) The offline task database 850 is also available for being queried by the offline task management server 820. When a user submits an offline task, the offline task management server 820 searches the offline task database 850 for a file that is downloaded completely and requested by the offline task, and the file is directly returned to the download client 810 so that the download client 810 can instantly download the requested file.

(4) The offline task database 850 is further configured to receive synchronization of eliminating files. For space reasons, obsolete or infrequently accessed files need to be deleted from the cloud storage server 830, and the offline task database 850 needs to be updated.

Offline download server 860:

(1) As scheduled by an offline task distribution server 870, the offline download server 860 obtains a download address link from the offline task database 850 to download an offline task.

(2) The offline download server 860 stores completely downloaded data information into the cloud storage server 830 so that the data information is available for being retrieved by the download client 810.

(3) The offline download server 860 reports progress and speed of the offline download to the offline task distribution server 870.

(4) The offline download server 860 writes Hash result data of a final file generated in the offline download into the offline task database 850.

5. Offline task distribution server 870

(1) The offline task distribution server 870 receives load information reported by the offline download server 860.

(2) According to the load information reported by the offline download server 860, the offline task distribution server 870 dynamically schedules offline tasks onto different offline download servers 860 so that download tasks are performed.

(3) The offline task distribution server 870 receives reports about download progress information and download speed information from the offline download server 860, and synchronizes the progress information to the offline task management server 820.

(4) The offline task distribution server 870 filters out duplicate offline task download requests. The same offline task download request needs to be sent to the offline download server 860 only once, and different users can share offline download progress information of the same offline task.

6. Offline task management server 820

(1) The offline task management server 820 receives offline task download requests submitted by the download client 810, and generates a unique identification sequence number for each unique offline task.

(2) The offline task management server 820 writes original link information of the offline task into the offline task database 850.

(3) The offline task management server 820 receives download progress reports from the offline task distribution server 870, and makes the offline download progress available for being queried by the download client 810.

(4) According to the mapping record in the offline task database 850, the offline task management server 820 may notify offline download success to the user directly when discovering any data information that has been downloaded offline completely on the server.

(5) When the download client needs to retrieve the data information downloaded offline completely, the offline task management server 820 provides a portal address url from which the download client 810 can retrieve the data information, and the portal address serves as a download source address for the download client 810.

7. Cloud storage server 830:

(1) The cloud storage server 830 stores the data information that is downloaded completely on the offline download server 860.

(2) The cloud storage server 830 provides the download client 810 with a data source address of the data information retrieved offline.

(3) The cloud storage server 830 provides a transcoding server 710 with a data source for transcoding output.

8. Statistics server 880:

(1) The statistics server 880 receives reports from the download client 810, where the reports include information such as Url download speed, download time, network connectivity, download result, and file size during and after the download process.

(2) The statistics server 880 writes the reported statistics information as logs, which are available for future statistics and analysis.

(3) The statistics server 880 synchronizes a user download statistics result to a transcoding scheduling server 740, so that the transcoding scheduling server 740 can count video files that have been downloaded by users for a number of times more than a set threshold within a set time among the video files downloaded offline.

9. Video play format matching server 730:

(1) The video play format matching server 730 receives a file Hash value and an available bandwidth of the play client 840, where the file Hash value is provided by the play client 840 when a file in the offline space is chosen for playing.

(2) The video play format matching server 730 queries a transcoding aggregation result database 820, and returns a transcoded file that matches the bandwidth of the play client 840 to the play client 840. The transcoded file is a transcoded file that has a code rate matching the bandwidth of the play client 840 and has a video format supported by the play client 840 according to query based on the Hash value of the file to be played.

Transcoding scheduling server 740:

(1) According to the statistics result such as popularity and results of downloading video files as provided or statisticized by the statistics server 880, the transcoding scheduling server 740 proactively transcodes video files in the offline space into a video format suitable for playing on a browser and various terminals.

(2) The transcoding scheduling server 740 distributes video files that need transcoding to one or more transcoding servers 710 for transcoding.

11. Transcoding server 710:

(1) As scheduled by the transcoding scheduling server 740, the transcoding server 710 downloads an original video file from the cloud storage server 830 for transcoding.

(2) The transcoding server 710 obtains transcoding result information of the original video file, including a Hash value of the original video file, a Hash value of the transcoded file, transcoding parameters, resolution, frame rate, and so on.

(3) The transcoding server 710 stores the transcoding result information into a transcoding aggregation result database 720.

12. Video aggregation analysis server 760:

(1) The video aggregation analysis server 760 drags and drops video file information from the cloud storage server 830 and the offline task database 850 for performing aggregation analysis.

(2) The video aggregation analysis server 760 performs aggregation analysis for video files with the same visual perception effect, and stores an analysis result into a transcoding aggregation result database 720. If failing to find a file suitable for playing in the query process, the play client 840 may search the transcoding aggregation result database 720 for another file suitable for playing.

13. Transcoding aggregation result database 720:

(1) The transcoding aggregation result database 720 receives transcoding result information synchronized from one or more transcoding servers 710.

(2) The transcoding aggregation result database 720 receives aggregation results from the video aggregation analysis server 760.

(3) The transcoding aggregation result database 720 allows the video play format matching server 730 to search for similar files in it. If a video file is not instantly downloadable or directly playable, a video file similar to it may be obtained by searching the transcoding aggregation result database 720 and recommended to the user as a substitute of the file chosen by the user. Due to aggregation of video files, only one counterpart of similar video files is retained.

Described above is a system. The following expounds a method:

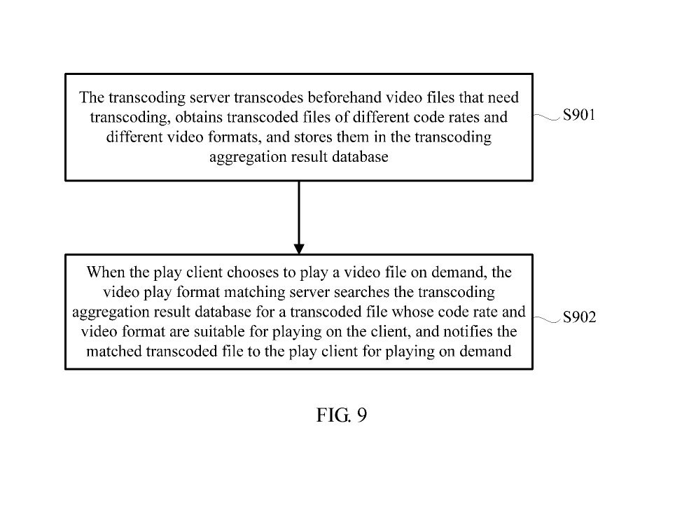

FIG. 9 is a flowchart of a multimedia file download method. The method is also referred to as a video-on-demand method. The method is applicable to the system shown in FIG. 7 and/or FIG. 8, and the method includes the following steps:

Step S901: The transcoding server transcodes beforehand video files that need transcoding, obtains transcoded files of different code rates and different video formats, and stores them in the transcoding aggregation result database.

The video files that need transcoding include: video files downloaded offline, and/or video files that are proactively scheduled by the transcoding scheduling server to the transcoding server for transcoding.

In some embodiments, the video files that are proactively scheduled by the transcoding scheduling server to the transcoding server for transcoding are: video files that have been downloaded by users for a number of times more than a set threshold within a set time among the video files downloaded offline.

Step S902: When the play client chooses to play a video file on demand, the video play format matching server searches the transcoding aggregation result database for a transcoded file whose code rate and video format are suitable for playing on the client, and notifies the matched transcoded file to the play client for playing on demand.

In some embodiments, the transcoded file suitable for playing on the client is obtained by transcoding the video file chosen by the client for playing on demand, and has a code rate that matches bandwidth of the client and has a video format supported by the client.

Also, in some embodiments, during or before step S901, the method further includes: the video aggregation analysis server aggregates similar video files in the video files downloaded offline, and stores an aggregation result into the transcoding aggregation result database.

Therefore, in some embodiments, if, in step S902, the video play format matching server finds no transcoded file suitable for playing on the client, the video play format matching server recommends to the play client another video file that is in an aggregated relationship with the video file chosen by the play client for playing on demand, so that the play client chooses whether to play the recommended video file on demand.

Also, in some embodiments, in step S902, the notifying the found transcoded file to the play client for playing on demand may specifically include:

By adding a link such as ed2k, http, and ftp, the play client uses cloud-on-demand to play the transcoded file on demand; or

A video link, a video download address or a BT seed corresponding to the found transcoded file is obtained and provided for the client, so that the client adds the video link, the video download address or the BT seed and uses cloud-on-demand to enable click-to-play of the transcoded file. For example, if the client obtains a video link, a video-on-demand request is submitted to an offline download page. On the offline download page, the desired file is opened. Because the file has been transcoded to match the bandwidth of the client, a user can click to play the transcoded file directly. If the client obtains a video download address, the user inputs the video download address on a cloud-on-demand homepage, submits the input, and then selects cloud-on-demand. If the client obtains a BT seed, the user adds the BT seed on the cloud-on-demand homepage for uploading, submits the input, and then selects cloud-on-demand.

Through cloud-on-demand, a video can be watched online directly through a video link such as a video download address or a BT seed, without requiring download. Moreover, because the cloud-on-demand file has been transcoded into a video format and a code rate that are suitable for playing on the play client, a drag-and-drop operation is supported to achieve an instant response, and the user can drag the progress arbitrarily, which is generally responded to within 2-7 seconds.

Also, in some embodiments, a file to be played is transcoded beforehand into a video format supported by the client. Therefore, embodiments described in the present disclosure support click-to-play of all video formats, and avoid various errors caused by file formats in the traditional play-while-downloading technology, which makes the biggest difference compared to the traditional play-while-downloading technology. Also, in some embodiments, a video file is transcoded into different code rates beforehand, and therefore, it may be chosen to play the original file to experience quality of the original file if the bandwidth permits, and it may be chosen a lower definition to ensure smooth play if the bandwidth is not enough to support play-while-downloading of a large file. The download process is transparent to the user. A video file link is obtained on the Internet such as from a forum or an email. Through a cloud-on-demand technology, the user can click the link to play directly, so that the user can watch and play a video anywhere, anytime through any device.

Described above is the multimedia file download method.

As revealed in the foregoing technical solution, embodiments described in the present disclosure achieve the following effects:

1. In the present disclosure, a video link, or a download link address, or a BT seed of a video file is notified to a play client to support direct video play. In this way, on an email or forum, if the corresponding video file link is instantly downloadable in an offline space, the video is directly playable to a great extent.

2. In the present disclosure, code rates and video formats are distinguished on the transcoding server, and the transcoding server masks differences of video formats and code rates. A proper playable file may be matched according to the available bandwidth of the play client and the video format supported by the play client, and a cloud-on-demand function is applicable to the files that have a high code rate and are not suitable for playing on a low-bandwidth client in the prior art.

3. In the present disclosure, a video file can be played online directly on demand through a play plug-in such as Flash supported by a browser, without installing client software.

Overall, the video-on-demand method and system provided in embodiments described in the present disclosure enable click-to-play of a video file by matching the video file format and the code rate that are suitable for playing.

Embodiments described in the present disclosure provide a video-on-demand system, which includes a client, and the system further includes a transcoding server, a video play format matching server, and a transcoding aggregation result database.

The transcoding server is configured to transcode the video file that needs transcoding, obtain transcoded files of different code rates and different video formats, and store them in the transcoding aggregation result database.

The transcoding aggregation result database is configured to store each transcoded file obtained by the transcoding server.

The video play format matching server is configured to: in view of a video file chosen by the client for playing on demand, search the transcoding aggregation result database for a transcoded file whose code rate and video format are suitable for playing on the client, and notify the matched transcoded file to the client for playing on demand.

In some embodiments, the above system includes a transcoding scheduling server; and

The video files that need transcoding include: video files downloaded offline, and/or video files that are scheduled by the transcoding scheduling server to the transcoding server for transcoding.

In some embodiments, in the above system, the video files that are scheduled by the transcoding scheduling server to the transcoding server for transcoding are: video files that have been downloaded by users for a number of times more than a set threshold within a set time among the video files downloaded offline.

In some embodiments, the system further includes:

a video aggregation analysis server, configured to aggregate similar video files in the video files downloaded offline, and store an aggregation result into the transcoding aggregation result database, where

the video play format matching server is configured to: if no transcoded file suitable for playing on the client is found, recommend to the client another video file that is in an aggregated relationship with the video file chosen by the client for playing on demand, so that the client chooses whether to play the recommended video file on demand.

In some embodiments, in the above system, the transcoded file suitable for playing on the client is obtained by transcoding the video file chosen by the client for playing on demand, and has a code rate that matches bandwidth of the client and has a video format supported by the client.

Embodiments described in the present disclosure provide a video-on-demand method, which is applied to the foregoing system and includes the following steps:

A. the transcoding server transcodes beforehand a video file that needs transcoding, obtains transcoded files of different code rates and different video formats, and stores them in the transcoding aggregation result database.

B. When a client chooses to play a video file on demand, the video play format matching server searches the transcoding aggregation result database for a transcoded file whose code rate and video format are suitable for playing on the client, and notifies the matched transcoded file to the client for playing on demand.

In some embodiments, in step A in the above method, the video files that need transcoding include: video files downloaded offline, and/or video files that are proactively scheduled by the transcoding scheduling server to the transcoding server for transcoding.

In some embodiments, in the above method, the video files that are proactively scheduled by the transcoding scheduling server to the transcoding server for transcoding are: video files that have been downloaded by users for a number of times more than a set threshold within a set time among the video files downloaded offline.

In some embodiments, during or before step A in the above method, the method further includes: the video aggregation analysis server aggregates similar video files in the video files downloaded offline, and stores an aggregation result into the transcoding aggregation result database; and

Correspondingly, in step B, the video play format matching server is configured to: if no transcoded file suitable for playing on the client is found, recommend to the client another video file that is in an aggregated relationship with the video file chosen by the client for playing on demand, so that the client chooses whether to play the recommended video file on demand.

In some embodiments, in the above method, the notifying the matched transcoded file to the client for playing on demand includes:

obtaining and providing a video link, a video download address or a BT seed corresponding to the matched transcoded file for the client; and

the client adds the video link, the video download address or the BT seed, and uses cloud-on-demand to enable click-to-play of the transcoded file.

In some embodiments, in the above method, the transcoded file suitable for playing on the client is obtained by transcoding the video file chosen by the client for playing on demand, and has a code rate that matches bandwidth of the client and has a video format supported by the client.

The multimedia file download method applied to video-on-demand is helpful to solve problems of most existing network videos that tend to give wrong contents of a similar topic, and avoids the consequence that a user finds the network video undesired after much time and bandwidth are consumed for downloading the network video.

The technical solution provided also supports play-while-downloading in the video-on-demand technology, and is not limited to specific video file formats such as QQ Tornado, Thunder, and so on; and the video file formats that support play-while-downloading are not limited to RM and RMVB. The RM and the RMVB are audio-video compression standards developed by Real Networks Corporation. The user may use RealPlayer or RealOne Player to live broadcast network audio/video resources compliant with the standards, but other video formats are not well supported. When playing and downloading a video file, the multimedia file download method takes account of the relationship between the code rate of the video file and the user bandwidth. Therefore, the code rate of the transcoded video file matches the user bandwidth, transmission interruption of the video file is avoided, and smooth play is ensured.

The multimedia file download method and the system thereof are also applicable to other scenarios of downloading multimedia files, such as a scenario that the transcoding server performs transcoding according to a real-time requirement of a client.

The operation of returning the transcoded file to a client according to a requirement of the client may specifically include: obtaining an original multimedia identifier from the client; searching for a transcoded multimedia identifier corresponding to the original multimedia identifier according to a stored mapping relationship between the original multimedia identifier and the transcoded multimedia identifier; obtaining the transcoded file according to the transcoded multimedia identifier; and returning the obtained transcoded file to the client.

The operation order is not definite between the step of obtaining the transcoded file generated as a result of transcoding a multimedia file by the transcoding server and the step of obtaining the client requirements. For example, the transcoding may be performed according to preset client requirements, and preferably, the transcoding is performed after the client requirements are obtained in real time. The following provides details with reference to embodiments.

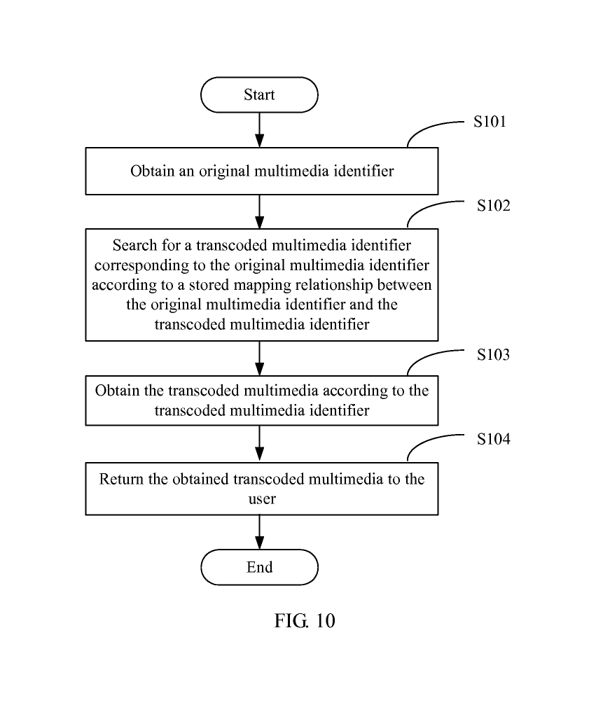

FIG. 10 is a flowchart of a multimedia file download method. As shown in FIG. 10, the embodiment primarily deals with the transcoding operation in a multimedia download process, and may also be referred to as a multimedia transcoding method. The method includes the following steps:

Step S101: Obtain an original multimedia identifier from a client.

In some embodiments, the multimedia identifier may be a multimedia information digest value, such as an SHA Hash value of a file, an MD5 Hash value, and so on. In some embodiments, the multimedia identifier may be a symbol sequence or numerical sequence that uniquely identifies the multimedia and has a small amount of information.

In some embodiments, the original multimedia information such as multimedia name and file path, which is input by the user and needs transcoding, may be obtained through a user interface provided by the client; the original multimedia corresponding to the multimedia name and the file path is obtained; the client obtains an information digest value of the original multimedia by using an information digest algorithm, and uploads it to a server; and the server receives the information digest value of the original multimedia that is uploaded by the client.

Step S102: Search for a transcoded multimedia identifier corresponding to the original multimedia identifier according to a stored mapping relationship between the original multimedia identifier and the transcoded multimedia identifier.

In some embodiments, the transcoded multimedia identifier stored on the server may be obtained beforehand, and a table of mapping relationships between the original multimedia identifier and the transcoded multimedia identifier may be stored. In step S102, the mapping relationship table may be searched for the transcoded multimedia identifier corresponding to the original multimedia identifier.

Step S103: Obtain the transcoded multimedia, that is, the transcoded file, according to the transcoded multimedia identifier.

Step S104: Return the obtained transcoded multimedia to the client.

FIG. 11 is a flowchart of a multimedia file download method. FIG. 11 further optimizes S103 shown in FIG. 10, and includes the following steps:

Step S1031: Obtain basic information and a download address of the transcoded multimedia corresponding to the transcoded multimedia identifier.

In some embodiments, the basic information may include file name, file size, format information, creation time, count of downloads, and so on.

Step S1032: Return the obtained basic information and download address to the client.

In some embodiments, it is appropriate to pre-store a table of mapping relationships between the transcoded multimedia identifier and the basic information together with the download address of the transcoded multimedia. The same original multimedia may correspond to different transcoded multimedia that has different basic information. Therefore, after the transcoded multimedia identifier corresponding to the original multimedia identifier is found, the mapping relationship table may be searched for the basic information and the download address of the transcoded multimedia corresponding to the transcoded multimedia identifier, and the basic information and the download address of the transcoded multimedia are returned to the client and readily displayable to the user, so that the user chooses the download address to download the transcoded multimedia according to the basic information of the transcoded multimedia.

Step S1033: Obtain the transcoded multimedia chosen by the client.

The transcoded multimedia may be obtained according to the download address of the transcoded multimedia chosen by the user.

In the multimedia transcoding method described above, the original multimedia identifier specified by the user is obtained, and the transcoded multimedia identifier corresponding to the original multimedia identifier is searched out; the transcoded multimedia are obtained according to the transcoded multimedia identifier, and the obtained transcoded multimedia are returned to the client. In this way, the multimedia are transcoded and the original multimedia need no more transcoding, which saves the transcoding time and improves efficiency of multimedia transcoding.

In some embodiments, the basic information of the transcoded multimedia may include format information of the transcoded multimedia.

The format information may include: file type, resolution, code rate, frame rate, and so on. In some embodiments, the basic information of the transcoded multimedia further includes file name, file size, creation time, count of downloads, and so on.

In some embodiments, the method may further include: obtaining transcoding parameters of original multimedia from the client.

The transcoding parameters of the original multimedia that need transcoding, which are input by the user, may be obtained through a user interface provided by the client.

In some embodiments, the transcoding parameters of the original multimedia are format information of target transcoded multimedia required by the user and transcoded from the original multimedia, and include file type, resolution, code rate, frame rate, and so on. The transcoding parameters input by the user may include one or several of the parameters enumerated above. Because the transcoding parameter information such as file type, resolution, code rate, and frame rate is complicated, in some embodiments, it is appropriate to obtain a target platform or target device that will play the transcoded multimedia, which is input by the user, for example, a type of mobile device (mobile phone, MP4, and so on); and to obtain the transcoding parameters of the original multimedia according to the transcoding parameters that match the preset target platform or target device. In some embodiments, the user needs only to input the target platform or target device that will play the transcoded multimedia, and does not need to input complicated transcoding parameters, so that the user operations are convenient.

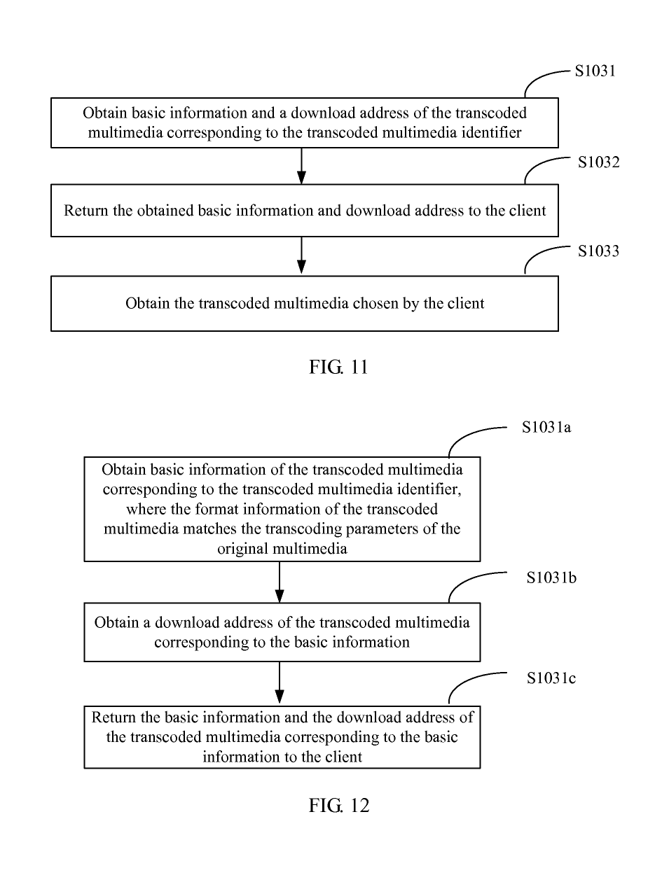

FIG. 12 is a flowchart of a multimedia file download method. FIG. 12 further optimizes step S1031, and includes the following steps:

Step S1031a: Obtain basic information of the transcoded multimedia corresponding to the transcoded multimedia identifier, where the format information of the transcoded multimedia matches the transcoding parameters of the original multimedia.

In some embodiments, it is appropriate to search out the basic information corresponding to the transcoded multimedia identifier, judge whether the format information of the basic information matches the transcoding parameters of the original multimedia, and obtain the basic information whose format information matches the transcoding parameters of the original multimedia. Specifically, a fuzzy match or an exact match may be performed between the format information of the basic information and the transcoding parameters of the original multimedia. For example, the original multimedia transcoding parameters uploaded by the user include a file type WMA and a resolution 200×300; through a fuzzy match between the transcoding parameters and the format information of the basic information, basic information of all transcoded multimedia with a WMA file type or a 200×300 resolution is obtained; through an exact match between the transcoding parameters and the format information of the basic information, only the basic information of transcoded multimedia with a WMA file type and a 200×300 resolution is obtained.

Step S1031b: Obtain a download address of the transcoded multimedia corresponding to the basic information.

Step S1031c: Return the basic information and the download address of the transcoded multimedia corresponding to the basic information to the client.

In some embodiments, the original multimedia identifier and transcoding parameters uploaded by the user are obtained, and the basic information and the download address of transcoded multimedia corresponding to the original multimedia identifier and the transcoding parameters are returned to the user; further, the transcoded multimedia chosen by the user are returned to the user, without having to transcode the original multimedia again, which saves the transcoding time and improves efficiency of multimedia transcoding. Moreover, the basic information of the transcoded multimedia, which is returned to the user, matches the transcoding parameters input by the user, so that the user requirements are closely met and that the user can conveniently choose desired multimedia for downloading.

In some embodiments, when only one transcoded multimedia file matches the original multimedia identifier and the transcoding parameters that are input by the user, it is not necessary to return the basic information or the download address of the transcoded multimedia to the user for selecting, but the transcoded multimedia are obtained directly according to the download address and returned to the user, which reduces user operations and improves convenience of user operations.

In some embodiments, the multimedia file download method further includes: obtaining original multimedia uploaded by the client, transcoding the original multimedia, and returning the transcoded multimedia to the client.

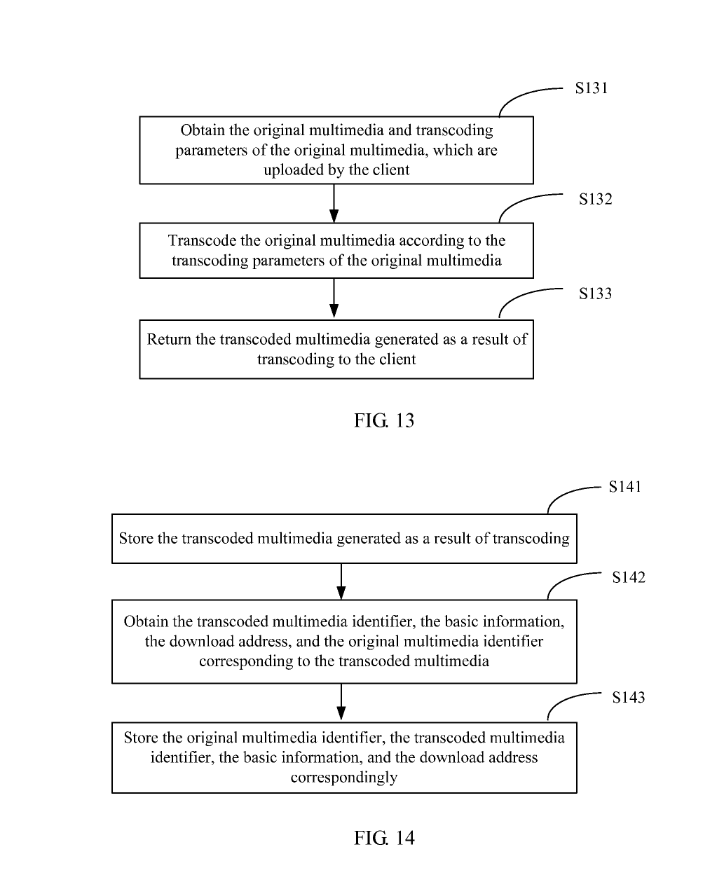

As shown in FIG. 13, the step of obtaining original multimedia uploaded by the client, transcoding the original multimedia, and returning the transcoded multimedia to the client includes the following steps:

Step S131: Obtain the original multimedia and transcoding parameters of the original multimedia, which are uploaded by the client.

A user interface of the client may provide an interface for uploading the original multimedia and the transcoding parameters of the original multimedia, and the user may use the interface to upload the original multimedia and the transcoding parameters of the original multimedia if no transcoded multimedia are found that match the original multimedia identifier or the transcoding parameters of the original multimedia, which are both input by the user, or, if the basic information of the transcoded multimedia, which is returned to the user, does not meet user requirements.

Step S132: Transcode the original multimedia according to the transcoding parameters of the original multimedia.

In some embodiments, the original multimedia uploaded by the user are obtained, and the transcoding server transcodes the original multimedia according to the uploaded transcoding parameters, and instructs the user to take back the multimedia upon completion of transcoding. The user may download the transcoded multimedia directly. In some embodiments, the user may query the progress of transcoding the original multimedia through the client. Because the transcoding server notifies the user upon completion of transcoding, the user does not need to heed whether the transcoding is complete in the transcoding process performed by the transcoding server, and therefore, offline transcoding is supported.

Step S133: Return the transcoded multimedia generated as a result of transcoding to the client.

In some embodiments, the original multimedia uploaded by the user are obtained if no transcoded multimedia are found that match the original multimedia identifier or the transcoding parameters of the original multimedia, which are both input by the user, or, if the basic information of the transcoded multimedia, which is returned to the user, does not meet user requirements; and the original multimedia are transcoded according to the transcoding parameters and returned to the user, without requiring the user to consume local system resources for transcoding. It is necessary only to upload the original multimedia and the transcoded multimedia returned by the download server. System resources and time consumed for uploading and downloading files are less than those consumed for transcoding the multimedia. Therefore, embodiments described in the present disclosure improve efficiency of transcoding the multimedia locally on the user side.

In some embodiments, after step S132, the multimedia transcoding method further includes: storing transcoded multimedia data.

As shown in FIG. 14, the storing the transcoded multimedia data includes the following steps:

Step S141: Store the transcoded multimedia generated as a result of transcoding.

In the step 141, the transcoded multimedia generated as a result of transcoding are stored so that they are available for repeated downloads by the user.

Step S142: Obtain the transcoded multimedia identifier, the basic information, the download address, and the original multimedia identifier corresponding to the transcoded multimedia.

In some embodiments, an information digest value of the transcoded multimedia may be obtained as a transcoded multimedia identifier, such as an SHA Hash value of a file, an MD5 Hash value, and so on. The type of the transcoded multimedia identifier obtained in step S142 is consistent with the type of the original multimedia identifier obtained in step S101. In some embodiments, the basic information of the transcoded multimedia, such as file name, file size, format information, creation time, and count of downloads, may be obtained, where the format information includes file type, resolution, code rate, frame rate, and so on.

Step S143: Store the original multimedia identifier, the transcoded multimedia identifier, the basic information, and the download address correspondingly.

It is appropriate to store a table of mapping relationships between the original multimedia identifier and the transcoded multimedia identifier, and a table of mapping relationships between the transcoded multimedia identifier and the basic information together with the download address.

In some embodiments, with the foregoing mapping relationship tables stored, when a user needs to transcode original multimedia, an identifier of the original multimedia can be obtained; according to the original multimedia identifier, a transcoded multimedia identifier is searched out in the mapping relationship table, thereby telling whether transcoded multimedia corresponding to the original multimedia identifier exist and speeding up the query. Further, it is appropriate to search the mapping relationship table for basic information and a download address that correspond to the transcoded multimedia identifier, and return the basic information and the download address to the user for selecting, and return the transcoded multimedia selected by the user to the user, without having to perform transcoding again. Therefore, the transcoding speed is improved.

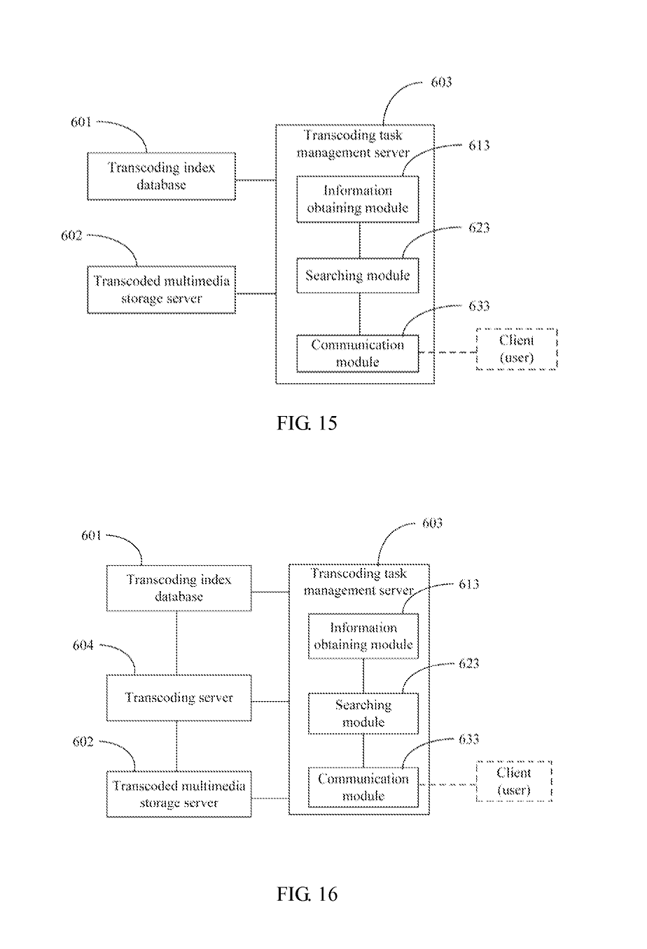

FIG. 15 is a schematic structural diagram of a multimedia download system. The download system primarily deals with multimedia transcoding operations, and therefore, the system may also be referred to as a multimedia transcoding system. As shown in FIG. 15, the multimedia transcoding system includes a transcoding index database 601, a transcoded multimedia storage server 602, and a transcoding task management server 603, where

the transcoding index database 601 is configured to store a mapping relationship between an original multimedia identifier and a transcoded multimedia identifier; and

the transcoded multimedia storage server 602 is configured to store transcoded multimedia, that is, transcoded files.

The transcoding task management server 603 includes an information obtaining module 613, a searching module 623, and a communication module 633, where

the information obtaining module 613 is configured to obtain the original multimedia identifier.

In some embodiments, the multimedia identifier may be a multimedia information digest value, such as an SHA Hash value of a file, an MD5 Hash value, and so on. In some embodiments, the multimedia identifier may be a symbol sequence or numerical sequence that uniquely identifies the multimedia and has a small amount of information.

In some embodiments, through a user interface provided by the client, the information obtaining module 613 may obtain original multimedia information such as multimedia name and file path, which is input by the user and needs transcoding; and may obtain the original multimedia corresponding to the multimedia name and the file path; the client obtains an information digest value of the original multimedia by using an information digest algorithm, and uploads it to the transcoding task management server; and the transcoding task management server receives the information digest value of the original multimedia that is uploaded by the client.

The searching module 623 is configured to search for a transcoded multimedia identifier corresponding to the original multimedia identifier according to a stored mapping relationship between the original multimedia identifier and the transcoded multimedia identifier, and obtain the transcoded multimedia from the transcoded multimedia storage server 602 according to the transcoded multimedia identifier.

The communication module 633 is configured to return the obtained transcoded multimedia to the user.

In the multimedia transcoding system described above, the original multimedia identifier specified by the user is obtained, and the transcoded multimedia identifier corresponding to the original multimedia identifier is searched out; the transcoded multimedia are obtained according to the transcoded multimedia identifier, and the obtained transcoded multimedia are returned to the user. In this way, the multimedia are transcoded and the original multimedia need no more transcoding, which saves the transcoding time and improves efficiency of multimedia transcoding.

In some embodiments, the transcoding index database 601 is further configured to store mapping relationships between the transcoded multimedia identifier and the basic information together with the download address of the transcoded multimedia.

In some embodiments, the searching module 623 is configured to search the transcoding index database for the transcoded multimedia identifier corresponding to the original multimedia identifier, and for the basic information and the download address of the transcoded multimedia corresponding to the transcoded multimedia identifier.

In some embodiments, the basic information includes file name, file size, format information, creation time, count of downloads, and so on.

The communication module 633 is configured to return the basic information and the download address to the user, obtain the transcoded multimedia chosen by the user, and return the transcoded multimedia chosen by the user to the user.

The same original multimedia may correspond to different transcoded multimedia that has different basic information. Therefore, after finding the transcoded multimedia identifier corresponding to the original multimedia identifier, the searching module 623 may further search the transcoding index database 601 for the basic information and the download address of the multimedia corresponding to the transcoded multimedia identifier, and the communication module 633 returns the basic information and the download address of the multimedia to the user so that the user chooses a download address to download the multimedia according to the basic information of the multimedia. Further, the communication module 633 may obtain the transcoded multimedia according to the download address of the transcoded multimedia chosen by the user, and return the transcoded multimedia to the user.

In some embodiments, the original multimedia identifier uploaded by the user is obtained, and the basic information and the download address of transcoded multimedia corresponding to the original multimedia identifier are returned to the user for selecting; further, the transcoded multimedia chosen by the user are returned to the user, without having to transcode the original multimedia again, which saves the transcoding time and improves efficiency of multimedia transcoding.

In some embodiments, the basic information of the transcoded multimedia includes format information of the transcoded multimedia.

The format information includes: file type, resolution, code rate, frame rate, and so on. In some embodiments, the basic information of the transcoded multimedia further includes file name, file size, creation time, count of downloads, and so on.

In some embodiments, the information obtaining module 613 is further configured to obtain transcoding parameters of original multimedia.

The information obtaining module 613 may, through a user interface provided by the client, obtain transcoding parameters of the original multimedia that need transcoding, which are input by the user.

In some embodiments, the transcoding parameters of the original multimedia are format information of target transcoded multimedia required by the user and transcoded from the original multimedia, and include file type, resolution, code rate, frame rate, and so on. The transcoding parameters input by the user may one or several of the information enumerated above. Because the transcoding parameter information such as file type, resolution, code rate, and frame rate are complicated, in some embodiments, the information obtaining module 613 may obtain a target platform or target device that will play the transcoded multimedia, which is input by the user, for example, a type of mobile device (mobile phone, MP4, and so on); and to obtain the transcoding parameters of the original multimedia according to the transcoding parameters that match the preset target platform or target device. In some embodiments, the user needs only to input the target platform or target device that will play the transcoded multimedia, and does not need to input complicated transcoding parameters, so that the user operations are convenient.

In some embodiments, the searching module 623 is configured to search the transcoding index database for the transcoded multimedia identifier corresponding to the original multimedia identifier, and for the basic information of the transcoded multimedia whose format information matches the transcoding parameters of the original multimedia, and obtain the download address of the transcoded multimedia corresponding to the basic information.

In some embodiments, the searching module 623 may search out the basic information corresponding to the transcoded multimedia identifier, judge whether the format information of the basic information matches the transcoding parameters of the original multimedia, and obtain the basic information whose format information matches the transcoding parameters of the original multimedia. The searching module 623 may perform a fuzzy match or an exact match between the format information of the basic information and the transcoding parameters of the original multimedia. For example, the original multimedia transcoding parameters uploaded by the user include a file type WMA and a resolution 200×300; through a fuzzy match between the transcoding parameters and the format information of the basic information, basic information of all transcoded multimedia with a WMA file type or a 200×300 resolution is obtained; through an exact match between the transcoding parameters and the format information of the basic information, only the basic information of transcoded multimedia with a WMA file type and a 200×300 resolution is obtained.

In some embodiments, the communication module 633 is configured to return to the user the basic information and the download address that are obtained by the searching module 623, obtain the transcoded multimedia chosen by the user, and return the transcoded multimedia chosen by the user to the user.

In some embodiments, the original multimedia identifier and transcoding parameters uploaded by the user are obtained, and the basic information and the download address of transcoded multimedia corresponding to the original multimedia identifier and the transcoding parameters are returned to the user; further, the transcoded multimedia chosen by the user are returned to the user, without having to transcode the original multimedia again, which saves the transcoding time and improves efficiency of multimedia transcoding. Moreover, the basic information of the transcoded multimedia, which is returned to the user, matches the transcoding parameters input by the user, so that the user requirements are closely met and that the user can conveniently choose desired multimedia for downloading.

In some embodiments, when the searching module 623 finds only one transcoded multimedia file matching the original multimedia identifier and the transcoding parameters that are input by the user, it is not necessary to return the basic information of the transcoded multimedia to the user for selecting, but the transcoded multimedia are obtained directly according to the download address, which reduces user operations and improves convenience of user operations.

In some embodiments, the information obtaining module 613 is further configured to obtain the original multimedia uploaded by the user and the transcoding parameters of the original multimedia.

A user interface of the client may provide an interface for uploading the original multimedia and the transcoding parameters of the original multimedia, and the user may use the interface to upload the original multimedia and the transcoding parameters of the original multimedia if no transcoded multimedia are found that match an original multimedia identifier or the transcoding parameters of the original multimedia, which are both input by the user, or, if the basic information of the transcoded multimedia, which is returned to the user, does not meet user requirements.

As shown in FIG. 16, the multimedia transcoding method further includes a transcoding server 604, configured to transcode the original multimedia according to the transcoding parameters of the original multimedia.

The transcoding server 604 may transcode the uploaded original multimedia according to the transcoding parameters uploaded by the user, and instruct the user to take back the multimedia upon completion of transcoding. The user may download the transcoded multimedia directly. In some embodiments, the user may query the progress of transcoding the original multimedia through the client. Because the transcoding server notifies the user upon completion of transcoding, the user does not need to heed whether the transcoding is complete in the transcoding process performed by the transcoding server, and therefore, offline transcoding is supported. In some embodiments, the transcoded multimedia storage server 602 is configured to store the transcoded multimedia generated as a result of transcoding by the transcoding server 604.

In some embodiments, the communication module 633 is further configured to return the transcoded multimedia generated as a result of transcoding to the user.

In some embodiments, the original multimedia uploaded by the user are obtained if no transcoded multimedia are found that match an original multimedia identifier or the transcoding parameters of the original multimedia, which are both input by the user, or, if the basic information of the transcoded multimedia, which is returned to the user, does not meet user requirements; and the original multimedia are transcoded according to the transcoding parameters and returned to the user, without requiring the user to consume local system resources for transcoding. It is necessary only to upload the original multimedia and the transcoding parameters by the download server. System resources and time consumed for uploading and downloading file are less than those consumed for transcoding the multimedia. Therefore, embodiments described in the present disclosure improve efficiency of transcoding the multimedia locally on the user side.

In some embodiments, the transcoding server 604 is further configured to obtain the transcoded multimedia identifier, the basic information, the download address, and the original multimedia identifier corresponding to the transcoded multimedia.

In some embodiments, the transcoding server 604 may obtain an information digest value of the transcoded multimedia as a transcoded multimedia identifier, such as an SHA Hash value of a file, an MD5 Hash value, and so on. The type of the transcoded multimedia identifier obtained by the transcoding server 604 is consistent with the type of the original multimedia identifier obtained by the information obtaining module 613. In some embodiments, the transcoding server 604 may obtain basic information of the transcoded multimedia, such as file name, file size, format information, creation time, and count of downloads, where the format information includes file type, resolution, code rate, frame rate, and so on.

In some embodiments, the transcoding index database 601 is configured to store a mapping relationship between the transcoded multimedia identifier obtained by the transcoding server 604 and the original multimedia identifier, and a mapping relationship between the transcoded multimedia identifier and the basic information together with the download address.

In some embodiments, the transcoding index database 601 stores the foregoing mapping relationships. Therefore, when a user needs to transcode original multimedia, an identifier of the original multimedia can be obtained; according to the original multimedia identifier, a transcoded multimedia identifier is searched out in the mapping relationship table, thereby telling whether transcoded multimedia corresponding to the original multimedia identifier exist and speeding up the query. Further, it is appropriate to search the mapping relationship table for basic information and a download address that correspond to the transcoded multimedia identifier, and return the basic information and the download address to the user for selecting, and return the transcoded multimedia selected by the user to the user, without having to perform transcoding again. Therefore, the transcoding speed is improved.

Overall, embodiments described in the present disclosure provide a multimedia transcoding method, including:

obtaining an original multimedia identifier;

searching for a transcoded multimedia identifier corresponding to the original multimedia identifier according to a stored mapping relationship between the original multimedia identifier and the transcoded multimedia identifier;

obtaining the transcoded multimedia according to the transcoded multimedia identifier; and

returning the obtained transcoded multimedia to the user.

In some embodiments, the step of obtaining the transcoded multimedia according to the transcoded multimedia identifier includes:

obtaining basic information and a download address of the transcoded multimedia corresponding to the transcoded multimedia identifier;

returning the obtained basic information and download address to the user; and

obtaining the transcoded multimedia chosen by the user.

In some embodiments, the basic information of the transcoded multimedia includes format information of the transcoded multimedia.

The method further includes:

obtaining transcoding parameters of the original multimedia, where

the step of obtaining basic information and a download address of the transcoded multimedia corresponding to the transcoded multimedia identifier and returning the basic information and the download address to the user includes:

searching for basic information of the transcoded multimedia corresponding to the transcoded multimedia identifier, where the format information of the transcoded multimedia matches the transcoding parameters of the original multimedia; and

obtaining a download address of the transcoded multimedia corresponding to the basic information, and returning the basic information and the download address of the transcoded multimedia corresponding to the basic information to the user.

In some embodiments, the method further includes:

obtaining the original multimedia and transcoding parameters of the original multimedia, which are uploaded by the user;

transcoding the original multimedia according to the transcoding parameters of the original multimedia; and

returning the transcoded multimedia generated as a result of transcoding to the user.

In some embodiments, the method further includes:

storing the transcoded multimedia generated as a result of transcoding;

obtaining the transcoded multimedia identifier, the basic information, the download address, and the original multimedia identifier corresponding to the transcoded multimedia; and

storing the original multimedia identifier, the transcoded multimedia identifier, the basic information, and the download address correspondingly.

In some embodiments, the identifier is an information digest value of multimedia.

Therefore, it is necessary to provide a multimedia transcoding system to improve transcoding efficiency.

A multimedia transcoding system includes:

a transcoding index database, configured to store a mapping relationship between an original multimedia identifier and a transcoded multimedia identifier;

a transcoded multimedia storage server, configured to store transcoded multimedia; and

a transcoding task management server, where the transcoding task management server includes:

an information obtaining module, configured to obtain the original multimedia identifier;

a searching module, configured to: search the transcoding index database for the transcoded multimedia identifier corresponding to the original multimedia identifier, and obtain the transcoded multimedia from the transcoded multimedia storage server according to the transcoded multimedia identifier; and

a communication module, configured to return the obtained transcoded multimedia to the user.

In some embodiments, the transcoding index database is further configured to store mapping relationships between the transcoded multimedia identifier and the basic information together with the download address of the transcoded multimedia;

the searching module is configured to search the transcoding index database for the transcoded multimedia identifier corresponding to the original multimedia identifier, and for the basic information and the download address of the transcoded multimedia corresponding to the transcoded multimedia identifier; and

the communication module is configured to return the basic information and the download address to the user, obtain the transcoded multimedia chosen by the user, and return the transcoded multimedia chosen by the user to the user.

In some embodiments, the basic information of the transcoded multimedia includes format information of the transcoded multimedia;

the information obtaining module is further configured to obtain transcoding parameters of original multimedia;

the searching module is configured to search the transcoding index database for the transcoded multimedia identifier corresponding to the original multimedia identifier, and for the basic information of the transcoded multimedia whose format information matches the transcoding parameters of the original multimedia, and obtain the download address of the transcoded multimedia corresponding to the basic information; and

the communication module is configured to return the basic information and the download address of the transcoded multimedia corresponding to the basic information to the user, obtain the transcoded media chosen by the user, and return the transcoded multimedia chosen by the user to the user.

In some embodiments, the information obtaining module is further configured to obtain the original multimedia uploaded by the user and the transcoding parameters of the original multimedia;

the system further includes a transcoding server, configured to transcode the original multimedia according to the transcoding parameters of the original multimedia;

the transcoded multimedia storage server is configured to store transcoded multimedia generated as a result of transcoding by the transcoding server; and

the communication module is further configured to return the transcoded multimedia generated as a result of transcoding to the user.

In some embodiments, the transcoding server is further configured to obtain the transcoded multimedia identifier, the basic information, the download address, and the original multimedia identifier corresponding to the transcoded multimedia; and

the transcoding index database is configured to store a mapping relationship between the transcoded multimedia identifier obtained by the transcoding server and the original multimedia identifier, and a mapping relationship between the transcoded multimedia identifier and the basic information together with the download address.

In some embodiments, the identifier is an information digest value of multimedia.

In the multimedia transcoding method and system described above, the original multimedia identifier specified by the user is obtained, and the transcoded multimedia identifier corresponding to the original multimedia identifier is searched out; the transcoded multimedia are obtained according to the transcoded multimedia identifier, and the obtained transcoded multimedia are returned to the user. In this way, the multimedia are transcoded and the original multimedia need no more transcoding, which saves the transcoding time and improves efficiency of multimedia transcoding.

All or part of the steps in the various embodiments described above are provided by a processor that executes computer readable instructions stored in a memory, where the memory includes non-transitory computer readable storage media, such as random access memory (RAM), different types of read only memory (ROM), and disk storage including optical disk storage.

Finally, it should be noted that the foregoing embodiments are intended for describing the technical solutions of the present disclosure and are not provided to be limiting. Persons of ordinary skill in the art should understand that they may still make modifications to the technical solutions described in the foregoing embodiments, or make equivalent replacements to some or all the technical features thereof, without departing from the spirit and scope of the technical solutions of the embodiments of the present disclosure.

1.-40. (canceled)

41. An offline download system, comprising:
a download server cluster, wherein the download server cluster comprises at least two download servers, each of which is configured to feed back load information to a distribution server according to its own load and obtain data information from the Internet according to an offline task;
the distribution server, configured to obtain the offline task, communicatively connected with the download server cluster and configured to receive the load information, generate a scheduling rule according to the load information, and distribute the offline task to the download servers according to the scheduling rule; and
a storage server, communicatively connected with the download server cluster and configured to store the data information obtained by the download server cluster, and make the data information available for downloading.

42. The system according to claim 41, further comprising:
an offline task database, configured to store an original link of the offline task, wherein the download server cluster is communicatively connected with the offline task database and configured to obtain the original link of the offline task from the offline task database, and the download server cluster is further configured to write a portal address of data information corresponding to a completely downloaded offline task into the offline task database and generate a mapping record; and
an offline task manager, communicatively connected with the offline task database and the distribution server and configured to: judge according to the mapping record whether the offline task obtained by the distribution server is downloaded completely; if yes, provide the storage server directly with the data information of the completely downloaded offline task; if no, generate a unique sequence number for the offline task whose download is unfinished, write the sequence number and an original link of the offline task whose download is unfinished into the offline task database, and submit the offline task whose download is unfinished to the distribution server.

43. A multimedia file download method, comprising:
obtaining, by a transcoding server, a transcoded file generated by transcoding a multimedia file; and
returning the transcoded file to a client according to a requirement of the client.

44. The method according to claim 43, wherein:
the obtaining, by a transcoding server, a transcoded file generated by transcoding a multimedia file, comprises: transcoding, by the transcoding server beforehand, a video file that needs transcoding, and obtaining transcoded files of different code rates and different video formats and storing them in a transcoding aggregation result database; and
the returning the transcoded file to a client according to a requirement of the client comprises: searching, by a video play format matching server when the client chooses to play a video file on demand, the transcoding aggregation result database for a transcoded file whose code rate and video format are suitable for playing on the client, and notifying the matched transcoded file to the client for playing on demand.

45. The method according to claim 44, wherein:
the video files that need transcoding comprise: at least one of video files downloaded offline and video files that are proactively scheduled by a transcoding scheduling server to the transcoding server for transcoding.

46. The method according to claim 45, wherein:
the video files that are proactively scheduled by the transcoding scheduling server to the transcoding server for transcoding are: video files that have been downloaded for a number of times more than a set threshold within a set time among the video files downloaded offline.

47. The method according to claim 45, wherein:
while or before the transcoding server transcodes beforehand the video file that needs transcoding, obtains transcoded files of different code rates and different video formats, and stores them in a transcoding aggregation result database, the method further comprises:
aggregating, by a video aggregation analysis server, similar video files in the video files downloaded offline, and storing an aggregation result into the transcoding aggregation result database, wherein
correspondingly, when the client chooses to play a video file on demand, if the video play format matching server finds no transcoded file suitable for playing on the client in the transcoding aggregation result database, the video play format matching server recommends to the client another video file that is in an aggregated relationship with the video file chosen by the client for playing on demand, so as to make the client choose whether to play the recommended video file on demand.

48. The method according to claim 45, comprising:
obtaining data information of an offline task download as the video file that needs transcoding.

49. The method according to claim 44, wherein:
the notifying the matched transcoded file to the client for playing on demand comprises:
obtaining and providing a video link, a video download address or a BT seed corresponding to the matched transcoded file for the client, so that the client adds the video link, the video download address or the BT seed and uses cloud-on-demand to enable click-to-play of the transcoded file.

50. The method according to claim 44, wherein:
the transcoded file suitable for playing on the client is obtained by transcoding the video file chosen by the client for playing on demand, and has a code rate that matches bandwidth of the client and has a video format supported by the client.

51. The method according to claim 43, wherein:
the returning the transcoded file to a client according to the requirement of the client comprises:
obtaining an original multimedia identifier from the client;
searching for a transcoded multimedia identifier corresponding to the original multimedia identifier according to a stored mapping relationship between the original multimedia identifier and the transcoded multimedia identifier;
obtaining the transcoded file according to the transcoded multimedia identifier; and
returning the obtained transcoded file to the client.

52. The method according to claim 51, wherein:
the obtaining, by a transcoding server, a transcoded file generated by transcoding a multimedia file, comprises:
obtaining the original multimedia and transcoding parameters of the original multimedia, which are uploaded by the client; and
transcoding, by the transcoding server, the original multimedia according to the transcoding parameters of the original multimedia to obtain the transcoded file.

53. A multimedia file download system, comprising:
a transcoding server, configured to obtain a transcoded file generated by transcoding a multimedia file; and
a file returning server, configured to return the transcoded file to a client according to a requirement of the client.

54. The system according to claim 53, wherein:
the system further comprises a transcoding aggregation result database;
the transcoding server is specifically configured to transcode beforehand the video file that needs transcoding, obtain transcoded files of different code rates and different video formats, and store them in the transcoding aggregation result database;
the transcoding aggregation result database is configured to store each transcoded file obtained by the transcoding server; and
the file returning server is specifically a video play format matching server, and is configured to: in view of a video file chosen by the client for playing on demand, search the transcoding aggregation result database for a transcoded file whose code rate and video format are suitable for playing on the client, and notify the matched transcoded file to the client for playing on demand.

55. The system according to claim 54, wherein:
the system further comprises a transcoding scheduling server, configured to schedule video files that need transcoding to the transcoding server; and
the video files that need transcoding comprise: at least one of video files downloaded offline and video files that are scheduled by the transcoding scheduling server to the transcoding server for transcoding.

56. The system according to claim 55, wherein:
the video files that are scheduled by the transcoding scheduling server to the transcoding server for transcoding are video files that have been downloaded for a number of times more than a set threshold within a set time among the video files downloaded offline.

57. The system according to claim 55, further comprising:
a video aggregation analysis server, configured to aggregate similar video files in the video files downloaded offline, and store an aggregation result into the transcoding aggregation result database, wherein
the video play format matching server is further configured to: if no transcoded file suitable for playing on the client is found, recommend to the client another video file that is in an aggregated relationship with the video file chosen by the client for playing on demand, so as to make the client choose whether to play the recommended video file on demand.

58. The system according to claim 54, wherein:
the transcoded file suitable for playing on the client is obtained by transcoding the video file chosen by the client for playing on demand, and has a code rate that matches bandwidth of the client and has a video format supported by the client.

59. The system according to claim 53, wherein:
the system further comprises a transcoding index database and a transcoded multimedia storage server;
the transcoding index database is configured to store a mapping relationship between an original multimedia identifier and a transcoded multimedia identifier;
the transcoded multimedia storage server is configured to store transcoded files;
the file returning server is a transcoding task management server, and the transcoding task management server comprises:
an information obtaining module, configured to obtain the original multimedia identifier from the client;
a searching module, configured to: search the transcoding index database for the transcoded multimedia identifier corresponding to the original multimedia identifier, and obtain the transcoded file from the transcoded multimedia storage server according to the transcoded multimedia identifier; and
a communication module, configured to return the obtained transcoded file to the client.

60. The system according to claim 59, wherein:
the information obtaining module is further configured to obtain the original multimedia and the transcoding parameters of the original multimedia uploaded by the client;
the transcoding server is specifically configured to transcode the original multimedia according to the transcoding parameters of the original multimedia;
the transcoded multimedia storage server is configured to store transcoded files generated as a result of transcoding by the transcoding server; and
the communication module is further configured to return the transcoded files generated as a result of transcoding to the client.
